(19) United States
(12) Patent Application Publication
(10) Pub. No.: US 2026/0017858 A1
(43) Pub. Date: Jan. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KAZUYA OGASAWARA, Kanagawa (JP); KOUTA MURASAWA, Kanagawa (JP); TAKAYUKI YAMADA, Kanagawa (JP); FUMINO MATSUI, Kanagawa (JP); SHINJIRO HORI, Kanagawa (JP)

(21) Appl. No.: 19/262,353

(22) Filed: Jul. 8, 2025

(30) Foreign Application Priority Data
Jul. 9, 2024 (JP) 2024-110496

(51) Int. Cl. G06T 11/60; G06F 3/04842; G06F 40/186

(52) U.S. Cl. CPC G06T 11/60; G06F 3/04842; G06F 40/186

(57) ABSTRACT

The present disclosure is an information processing apparatus configured to generate data of a creation product, and includes: a reception unit configured receive designation of a content to be arranged in the creation product and designation of a target impression from a user, the target impression being an impression that is required to be eventually given by the creation product; and a control unit configured to perform control such that a range of the target impression designatable by the user in a case where the reception unit receives designation of a first content is different from a range of the target impression designatable by the user in a case where the reception unit receives designation of a second content different from the first content.

### CROSS-REFERENCE TO PRIORITY APPLICATION

### Background

This application claims the benefit of Japanese Patent Application No. 2024-110496, filed Jul. 9, 2024, which is hereby incorporated by reference herein in its entirety.

### FIELD OF THE TECHNOLOGY

The present disclosure relates to an information processing apparatus, an information processing method, and a storage medium.

### DESCRIPTION OF THE RELATED ART

As a method of creating design data of a poster by using an information processing apparatus such as a PC or a smartphone, there is a method of using a template in which shapes and arrangement of images, characters, graphics, and the like to be arranged in the poster are determined advance. Moreover, Japanese Patent Laid-Open No. 2024-004399 discloses an application program that generates poster data in which images, characters, graphics, and the like are automatically arranged in the case where a user designates an impression (target impression) of a poster desired to be created.

### SUMMARY

The present disclosure is an information processing apparatus configured to generate data of a creation product, and includes: a reception unit configured receive designation of a content to be arranged in the creation product and designation of a target impression from a user, the target impression being an impression that is required to be eventually given by the creation product; and a control unit configured to perform control such that a range of the target impression designatable by the user in a case where the reception unit receives designation of a first content is different from a range of the target impression designatable by the user in a case where the reception unit receives designation of a second content different from the first content.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a hardware configuration of a poster generation apparatus;

FIG. 2 is a software block diagram of a poster creation application;

FIG. 3 is a software block diagram of a target impression setting control component;

FIG. 4A is a diagram explaining a skeleton;

FIG. 4B is a diagram illustrating an example of metadata;

FIG. 5 is a diagram explaining a color scheme pattern;

FIG. 6 is a diagram illustrating a mode selection screen provided by the poster creation application;

FIG. 7 is a diagram illustrating a content setting screen provided by the poster creation application;

FIG. 8 is a diagram illustrating a generation condition setting screen provided by the poster creation application;

FIG. 9 is a diagram illustrating a preview screen provided by the poster creation application;

FIG. 10 is a flowchart illustrating a poster impression quantification process;

FIG. 11 is a diagram explaining a subjective evaluation of a poster;

FIG. 12A is a flowchart that illustrates a content impression quantification process and that explains an image impression quantification process;

FIG. 12B is a flowchart that illustrates the content impression quantification process and that explains a text impression quantification process;

FIG. 13 is a diagram comparing differences in a poster generation result depending on an operation mode;

FIG. 14 is a flowchart illustrating an operation mode switching process;

FIG. 15A is a flowchart illustrating a poster generation process in a content prioritized mode;

FIG. 15B is a flowchart of a condition determination process in S1507;

FIG. 16 is a flowchart illustrating a process of changing setting ranges of the target impression;

FIG. 17A is a diagram illustrating a method of determining the setting ranges of the target impression;

FIG. 17B is a diagram illustrating the method of determining the setting ranges of the target impression;

FIG. 17C is a diagram illustrating the method of determining the setting ranges of the target impression;

FIG. 17D is a diagram illustrating the method of determining the setting ranges of the target impression;

FIG. 17E is a diagram illustrating the method of determining the setting ranges of the target impression;

FIG. 17F is a diagram illustrating the method of determining the setting ranges of the target impression;

FIG. 18A is a diagram explaining a method of changing a UI for setting the target impression, and is an example of an impression slider having a reference range that is a default setting range;

FIG. 18B is a diagram explaining the method of changing the UI for setting the target impression, and is an example of the impression slider in the case where the setting range of liveliness is set to +0.2 or more and +2.0 or less;

FIG. 18C is a diagram explaining the method of changing the UI for setting the target impression, and is an example in which a movable range of a handle is limited;

FIG. 18D is a diagram explaining the method of changing the UI for setting the target impression, and is an example in which the impression slider corresponding to a fixed impression factor is set to a not-operable state;

FIG. 19A is a diagram that explains a method of selecting a skeleton and that illustrates an example of a table in which the skeletons are associated with the impressions;

FIG. 19B is a diagram that explains the method of selecting the skeleton, and is an example of distances determined in the case where the target impression is “premium feel +1, affinity −1, liveliness −2, and substantial feel +2”;

FIG. 19C is examples of the skeletons corresponding to Skelton 1 to Skelton 4 in FIG. 19A;

FIG. 20A is a diagram that explains a method of selecting a color scheme pattern and fonts and that illustrates an example of a color scheme pattern impression table;

FIG. 20B is a diagram that explains a method of selecting a color scheme pattern and fonts and that illustrates an example of a font impression table;

FIG. 21 is a software block diagram explaining a layout component in detail;

FIG. 22 is a flowchart illustrating a layout process;

FIG. 23A is a diagram explaining input into the layout component, and is a table summarizing character information designated in a text designation component 202 and an image designated in an image designation component;

FIG. 23B is a diagram explaining input into the layout component, and is an example of a table illustrating color scheme patterns obtained from a color scheme pattern selection component;

FIG. 23C is a diagram explaining input into the layout component, and is an example of a table illustrating fonts obtained from a font selection component;

FIG. 24A is a diagram that explains operations of the layout component and that illustrates an example of the skeleton;

FIG. 24B is a diagram that explains operations of the layout component and that illustrates a state of the skeleton after execution of a color scheme application process;

FIG. 24C is a diagram that explains operations of the layout component and that illustrates an example of the skeleton after a process by a text arrangement component 2105;

FIG. 25A is a flowchart illustrating the poster generation process in an impression prioritized mode;

FIG. 25B is a flowchart that illustrates the poster generation process in an impression prioritized mode and that illustrates the condition determination process in S1507 performed by a skeleton obtaining component;

FIG. 26A is a diagram that illustrates a modification example of the UI for setting the target impression and that illustrates an example of setting the target impression with a UI on a radar chart

FIG. 26B is a diagram that illustrates the modification example of the UI for setting the target impression and that illustrates the radar chart in a state where one of impression factors is set to off;

FIG. 26C is a diagram that illustrates a modification example of the UI for setting the target impression and that illustrates an example of a UI for setting the target impression based on sample poster images instead of words;

FIG. 26D is a diagram illustrating the modification example of the UI for setting the target impression, and is a table illustrating impression values corresponding to the sample poster images of FIG. 26C and final target impression values.

FIG. 27A is a diagram that illustrates a modification example of the UI for setting the target impression and that illustrates an example of a UI for setting the target impression based on impression words;

FIG. 27B is a diagram illustrating the modification example of the UI for setting the target impression, and is a table that illustrates values of impression factors corresponding to each of the multiple impression words displayed in FIG. 27A and a final target impression;

FIG. 28 is a software block diagram of a poster creation application in a second embodiment;

FIG. 29 is a flowchart illustrating a template generation process in the content prioritized mode;

FIG. 30 is a software block diagram explaining a target impression setting control component of a third embodiment in detail;

FIG. 31 is a flowchart illustrating the process of changing the setting ranges of the target impression; and

FIG. 32 is a diagram explaining impression ranges of use application categories.

### DESCRIPTION OF THE EMBODIMENTS

In Japanese Patent Laid-Open No. 2024-004399, the user can freely designate images and texts (hereinafter, also collectively referred to as “contents”) to be used in the poster in addition to the target impression of the poster. Accordingly, the user can obtain a poster of a desired impression by using desired images.

However, even in the case where the contents desired to be used in the poster are determined, it is difficult for a user with a poor design skill to determine which target impression is to be designated to obtain a design with an impression suiting the contents. Accordingly, the user needs to seek out and designate the target impression.

The present disclosure is directed to improving the usability in cases where the user designates the target impression.

Embodiments of the present disclosure are explained below in detail with reference to the attached drawings. Note that the following embodiments do not limit the scope of claims, and not all of combinations of features explained in the present embodiment are necessarily essential for the present disclosure. Note that identical components are denoted by identical reference numerals, and explanation thereof is omitted.

### First Embodiment

In each of the embodiments illustrated below, explanation is given by using, as an example, a method in which an application for poster creation is operated in a poster generation apparatus to generate automatically-designed poster data. In a conventional poster creation application, an environment is such that a user can freely designate a target impression of a poster and a content to be arranged in the poster. Accordingly, in the case where a target impression that does not match the content designated by the user is set, the poster generated by the poster creation application is also outputted as a result not matching the content. Thus, the user needs to seek out the target impression by repeatedly designating the target impression until a poster of an intended design is obtained. In view of this, a poster creation application of a first embodiment changes ranges of the designatable target impression, depending on the content designated by the user to facilitate designation of the target impression suiting the content.

Note that, in the following explanation, “image” includes a still image and a frame image cut out from a video unless otherwise noted. Moreover, although explanation is given by using a poster as an example of a creation product in the following embodiments, the creation product is not limited to a poster. The embodiments can be used for any creation product that includes at least one of an image content and a text content such as a flyer, a menu, a banner, a calendar, a photocollage, a commendation, a security, a business card, a shop card, a post card, an invitation, a membership card, and the like. Moreover, these creation products may be used by being printed as well as used as electronic contents in a web site, an SNS, a virtual space, and the like.

### System Configuration

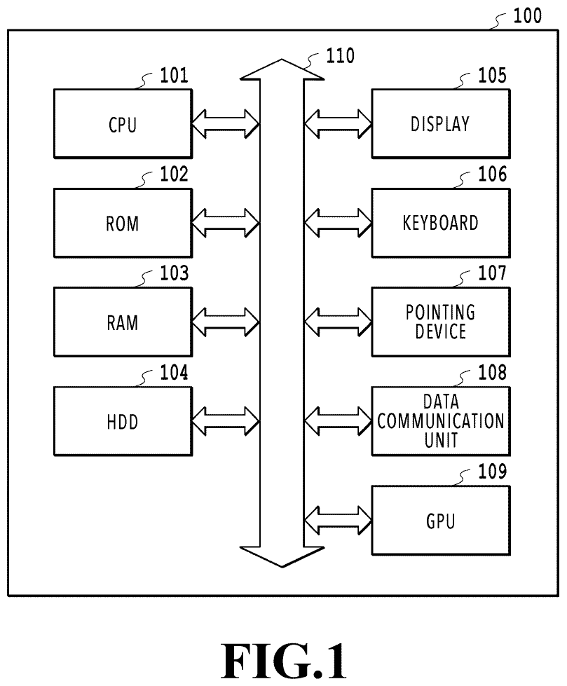

FIG. 1 is a block diagram illustrating a hardware configuration of the poster generation apparatus. Note that the poster generation apparatus 100 is an information processing apparatus, and a personal computer (hereinafter, referred to as PC), a smartphone, or the like can be given as an example. In the present embodiment, explanation is given assuming that the poster generation apparatus is a PC. The poster generation apparatus 100 includes a CPU 101, a ROM 102, a RAM 103, an HDD 104, a display 105, a keyboard 106, a pointing device 107, a data communication unit 108, and a GPU 109.

The CPU (central processing unit/processor) 101 integrally controls the poster generation apparatus 100, and implements operations of the present embodiment by, for example, reading out programs stored in the ROM 102 to the RAM 103 and executing the programs. Although there is one CPU in FIG. 1, multiple CPUs may be provided.

The ROM 102 is a general-purpose ROM, and, for example, programs to be executed by the CPU 101 are stored in the ROM 102. The RAM 103 is a general-purpose RAM, and is used as, for example, a working memory for temporarily storing various pieces of information in execution of the programs by the CPU 101.

The HDD (hard disk) 104 is a storage medium (storage unit) for storing an image file, a database holding processing results of image analysis and the like, a skeleton to be used by the poster creation application, and the like.

The display 105 is a display unit that displays a user interface (UI) of the present embodiment and displays an electronic poster as a layout result of image data (hereinafter, also referred to as “image”) to the user. The keyboard 106 and the pointing device 107 receive instruction operations from the user. The display 105 may have a touch sensor function.

For example, the keyboard 106 is used by the user to input the number of spreads of posters desired to be created on the UI displayed on the display 105.

For example, the pointing device 107 is used by the user to click a button on the UI displayed on the display 105.

The data communication unit 108 communicates with an external apparatus via a wired network, a wireless network, or the like. For example, the data communication unit 108 transmits data subjected to layout by an automatic layout function, to a printer or a server capable of communicating with the poster generation apparatus 100.

The GPU 109 is a processor that performs an image process by receiving a command from the CPU 101. For example, the GPU 109 generates a poster image by analyzing images to be arranged in the poster, estimating impressions of images or texts, estimating an impression of the poster, and executing color scheme assignment and layout of images, texts, and the like on a skeleton.

A data bus 110 communicably connects the blocks of FIG. 1 to one another. Note that the configuration illustrated in FIG. 1 is merely an example, and the present disclosure is not limited to this. For example, the poster generation apparatus 100 may include no display 105, and display the UI on an external display.

The poster creation application in the present embodiment is saved in the HDD 104. The poster creation application is activated in the case where the user executes an operation such as a click or a double click on an icon of the application displayed on the display 105 with the pointing device 107.

### Software Block Diagram

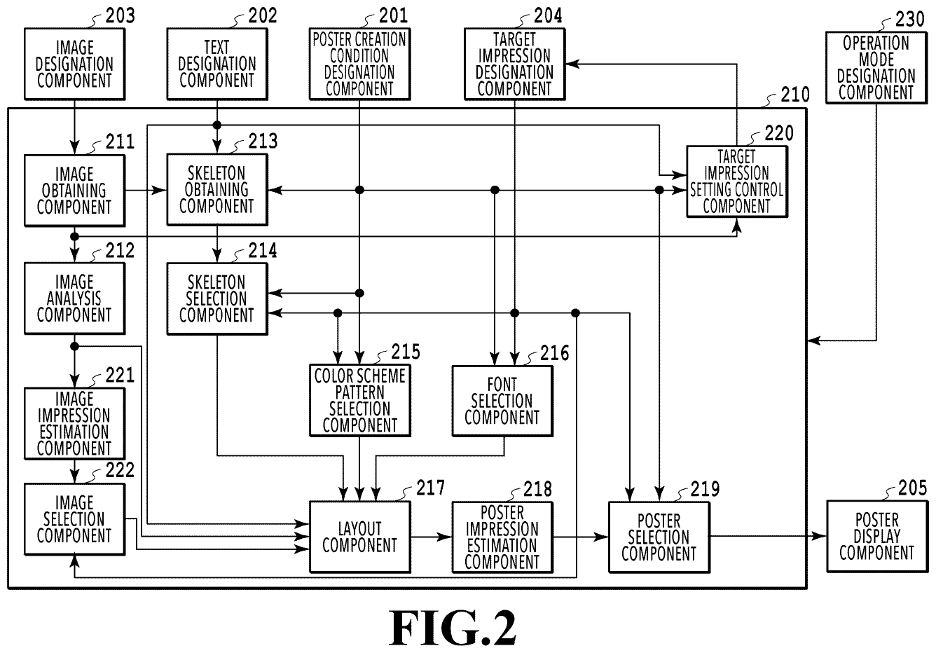

FIG. 2 is an example of a software block diagram of the poster creation application. The poster creation application includes a poster creation condition designation component 201, a text designation component 202, an image designation component 203, a target impression designation component 204, a poster display component 205, a poster generation component 210, and an operation mode designation component 230. The poster generation component 210 includes an image obtaining component 211, an image analysis component 212, a skeleton obtaining component 213, a skeleton selection component 214, a color scheme pattern selection component 215, a font selection component 216, a layout component 217, a poster impression estimation component 218, a poster selection component 219, a target impression setting control component 220, an image impression estimation component 221, and an image selection component 222. Moreover, FIG. 2 particularly illustrates a software block diagram relating to the poster generation component 210 that executes an automatic poster creation function.

In the case where the poster creation application is installed into the poster generation apparatus 100, an activation icon is displayed on a top screen (desktop) of an operating system (OS) operating on the poster generation apparatus 100, on the display 105. In the case where the activation icon is operated (for example, double-click operation) with the pointing device 107, the program of the poster creation application saved in the HDD 104 is loaded onto the RAM 103, and is executed by the CPU 101. The poster creation application is thereby activated.

Program modules corresponding to the respective components illustrated in FIG. 2 are included in the above-mentioned poster creation application. The CPU 101 executes each of the program modules to function as a corresponding one of the components illustrated in FIG. 2. Hereinafter, as explanation of the components illustrated in FIG. 2, the components are explained to execute various processes.

The operation mode designation component 230 designates an operation mode depending on a UI operation with the pointing device 107. In the present embodiment, there are two operation modes of a content prioritized mode and an impression prioritized mode. Details of each operation mode are described later. The operation mode designation component 230 outputs the designated operation mode to the poster generation component 210.

The poster creation condition designation component 201 designates poster creation conditions depending on a UI operation with the pointing device 107, for the poster generation component 210. In the present embodiment, the size, the creation number, and the use application category of the poster are designated as the poster creation conditions. Actual dimensional values of width and height or a sheet size such as A1 or A2 may be designated as the size of the poster. The use application category is a category indicating an application in which the poster is to be used, and is, for example, restaurant, school event, sale, awareness building, and the like. The creation conditions designated in the poster creation condition designation component 201 are inputted into the skeleton obtaining component 213, the skeleton selection component 214, the color scheme pattern selection component 215, the font selection component 216, the poster selection component 219, and the target impression setting control component 220.

The text designation component 202 receives designation of character information to be arranged in the poster, the designation performed by the user by performing a UI operation with the keyboard 106. The character information to be arranged on the poster represents, for example, character strings representing a title, time, date, location, and the like. Moreover, the text designation component 202 associates each piece of character information with information (tag or attribute information) indicating the type of the character information such as information indicating whether the character information is information indicating a title or information indicating time, date, and location, and then outputs the character information to the target impression setting control component 220, the skeleton obtaining component 213, and the layout component 217.

The image designation component 203 receives designation, by the user, of one or multiple pieces of image data to be arranged in the poster. For example, the designation of image data can be performed on the image data saved in the HDD 104, based on a structure of a file system including the image data such as a device or a directory. Moreover, the designation of image data may also be performed based on attribute information or additional information for identifying an image such as shooting date/time. Furthermore, the image designation component 203 may designate image data (hereinafter, also referred to as “application material image”) included in the poster creation application and provided as a material. Moreover, the image designation component 203 may designate image data (hereinafter, also referred to as “cooperation material image”) included in an external image providing service cooperating with the poster creation application. Furthermore, the image designation component 203 may designate image data generated by an image generative AI. A generative AI is a machine learning model that generates new data based on trained data, and the image generative AI is a generative AI that generates an image. Specifically, the image generative AI is an AI that can generate an image from a text or an image by using a diffusion model, a GAN model, or the like. The image designation component 203 outputs a file path of the designated image to the image obtaining component 211.

The target impression designation component 204 receives designation, by the user, of the target impression of the poster to be created. The target impression is an impression that is required to be eventually given by the poster to be created and that are set to be given to a person viewing the created poster (creation product). In the present embodiment, for each of words representing the impression, a UI operation with the pointing device 107 is performed to designate an intensity indicating how much the poster is to give the impression. Moreover, in the content prioritized mode to be described later, the target impression setting control component 220 determines ranges of the target impression designatable by the user in the target impression designation component 204. Note that, in a state before execution of the process of the target impression setting control component 220, a default range (reference range) set in advance is applied to the ranges of the designatable target impression. Information indicating the target impression designated in the target impression designation component 204 is shared with the skeleton selection component 214, the color scheme pattern selection component 215, the font selection component 216, the image selection component 222, and the poster selection component 219. Details of impressions are described later.

The poster generation component 210 executes a poster generation process depending on the operation mode designated in the operation mode designation component 230. The operation mode is described later.

Next, a software configuration of the poster generation component 210 is explained in detail.

The image obtaining component 211 obtains the one or multiple pieces of image data designated by the user in the image designation component 203, from the designated obtaining destination. The image obtaining component 211 outputs the obtained image data to the image analysis component 212 and the target impression setting control component 220. Moreover, the image obtaining component 211 outputs the number of obtained images to the skeleton obtaining component 213. The obtaining destination of the images includes the HDD 104, a storage region on the network, and the like. Moreover, the obtained images include still images, frame images cut out from a video, material images created in advance for the present application, material images provided by an image providing service, images generated by a generative AI, and the like. The still images and the frame images are images obtained from an imaging device such as a digital camera or a smart device. The imaging device may be included in the poster generation apparatus 100 or an external apparatus. Note that, in the case where the imaging device is the external device, the images are obtained via the data communication unit 108. Moreover, as another example, the still images may be illustration images created with image editing software or CG images created with CG creating software. The still images and cut-out images may be images obtained from a network or a server via the data communication unit 108. The images obtained from the network or the server include social networking service images (hereinafter, referred to as “SNS images”), material images, images provided outside the poster generation apparatus 100, and images generated by using a generative AI. Moreover, a program executed by the CPU 101 analyzes data attached to each image and determines a saving source for the image. For example, the obtaining destination of the SNS images may be managed in an application by obtaining the images from an SNS via the application. Note that the images are not limited to the images described above, and may be other types of images.

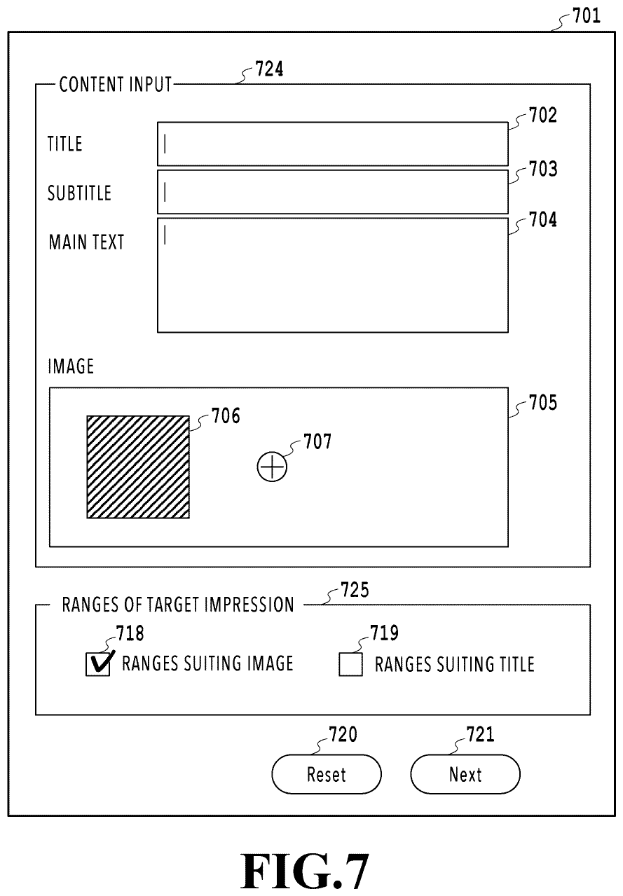

The target impression setting control component 220 obtains range change setting information designated by the poster creation condition designation component 201, the character information designated by the text designation component 202, and the image data obtained by the image obtaining component 211. The range change setting information is a parameter indicating how to control the ranges of the designatable target impression, and setting of the range change setting information by the user is received in the poster creation condition designation component 201. The setting of the range change setting information is described later (FIG. 7).

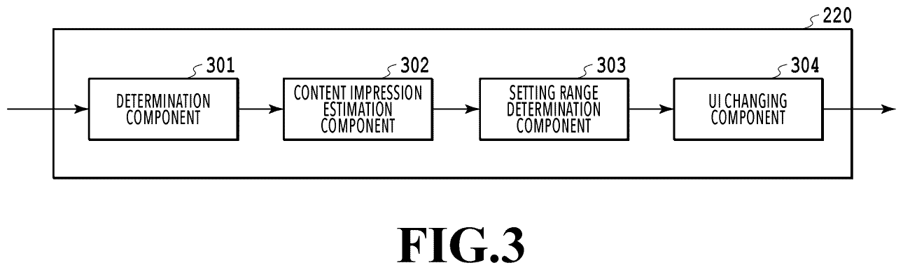

FIG. 3 is a software block diagram of the target impression setting control component 220. As illustrated in FIG. 3, the target impression setting control component 220 includes a determination component 301, a content impression estimation component 302, a setting range determination component 303, and a UI changing component 304.

The determination component 301 determines whether setting ranges of the target impression are to be changed or not, based on the range change setting information designated in the poster creation condition designation component 201. In the case where the determination component 301 determines that the setting ranges of the target impression are to be changed, the setting range determination component 303 determines the setting ranges that are the ranges of the target impression designatable by the user, based on at least one of the obtained text information and the obtained image data.

Note that, in the process of determining the setting ranges of the target impression, the setting range determination component 303 determines the setting ranges of the target impression, based on impressions of the image data obtained by the image obtaining component 211 and a text designated by the text designation component 202. The content impression estimation component 302 estimates the impressions of these contents (character information and image data), and outputs a result of the estimation to the setting range determination component 303. Note that the estimation of the impressions of the contents can be performed by using a trained model. The trained model for estimating the impressions of the contents is generated in a content impression quantification process to be described later.

In the case where the determination component 301 determines that the setting ranges of the target impression are not to be changed, the setting range determination component 303 determines the reference range determined in advance as the setting ranges of the target impression.

The UI changing component 304 changes or maintains a display form of a UI (operation object) such that the setting ranges of the target impression are set to the ranges determined by the setting range determination component 303, the UI used by the user to set the target impression. In the present embodiment, a slider is used as the operation object. The slider is an object in which the user designates a value by designating one point on a bar corresponding to a predetermined numerical value range by performing a slide operation. In the case where the target impression includes multiple impression factors, the slider is displayed on the display for each of the multiple impression factors. A specific display example of the UI is described later. The UI changing component 304 outputs the changed UI to the target impression designation component 204.

Returning to the explanation of FIG. 2, the image analysis component 212 executes an image data analysis process on the image data obtained from the image obtaining component 211, and obtains information indicating image feature values. Specifically, the image analysis component 212 executes an object recognition process to be described later, and obtains the information indicating the image feature values of the image data. Moreover, the image analysis component 212 associates the obtained information indicating the image feature values with the image data, and outputs the image data to the layout component 217 and the image impression estimation component 221.

The skeleton obtaining component 213 obtains one or multiple skeletons matching the conditions designated in the poster creation condition designation component 201, the text designation component 202, and the image obtaining component 211, from the HDD 104. In the present embodiment, skeletons are each information indicating arrangement of contents (character strings and images), graphics, and the like to be arranged in the poster.

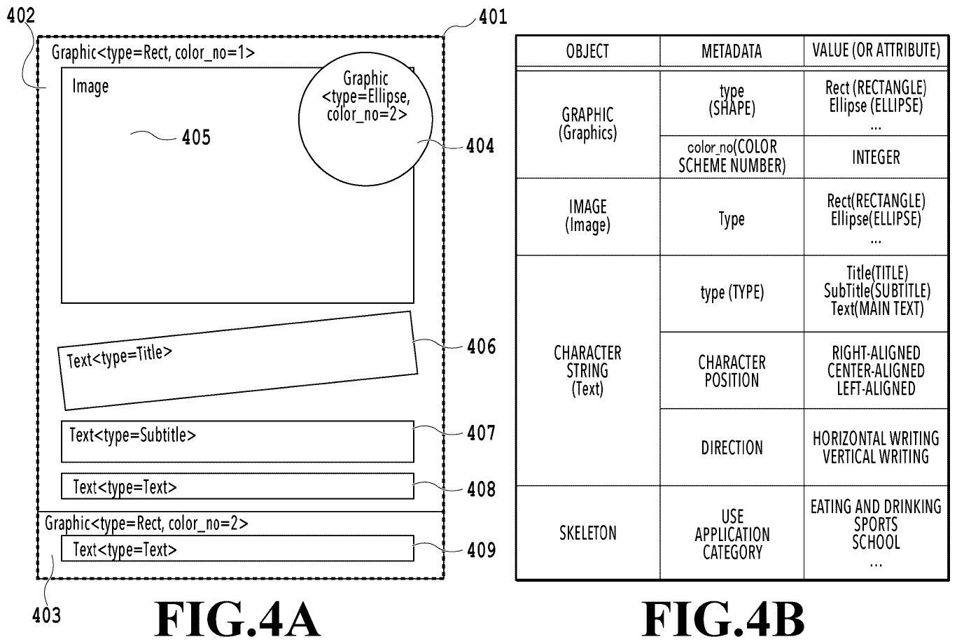

FIGS. 4A and 4B are diagrams illustrating an example of the skeleton. Three graphical objects 402, 403, and 404, one image object 405, and four text objects 406, 407, 408, and 409 that are objects in which characters are to be arranged are arranged on a skeleton 401 of FIG. 4A. In each object, a position indicating a location where the object is arranged, the size and angle of the object, and metadata necessary for generation of the poster are recorded. FIG. 4B is a diagram illustrating an example of the metadata. For example, which type of character information is to be arranged is held in each of the text objects 406 to 409 as an attribute of the metadata. In this example, it is illustrated that a title is to be arranged in the text object 406, a subtitle is to be arranged in the text object 407, and main texts are to be arranged in the text objects 407 and 408. Moreover, a shape of a graphic and a color scheme number (color scheme ID) indicating a color scheme pattern are held in each of the graphical objects 402 to 404 as the attribute of the metadata. In this example, it is illustrated that the attributes of the graphical objects 402 and 403 are rectangle and the attribute of the graphical object 404 is ellipse. Moreover, a color scheme number 1 is assumed to be assigned to the graphical object 402, and a color scheme number 2 is assumed to be assigned to the graphical objects 403 and 404. In this example, it is illustrated that the color scheme number is information referred to in color scheme application to be described later, and different colors are assigned to different color scheme numbers. Note that the types of objects and metadata are not limited to those described above. For example, a map object for arranging a map or a barcode object for arranging a QR code (registered trademark) or a barcode may be provided. Moreover, metadata indicating a space between lines and a space between characters may be provided as the metadata of the text object. The configuration may be such that the metadata includes a use application of the skeleton, and the use application is used for control of allowing or not allowing use of the skeleton depending on use application.

For example, the skeleton may be saved in the HDD 104 in a CSV format or in a DB format such as SQL. The skeleton obtaining component 213 outputs the one or multiple skeletons obtained from the HDD 104, to the skeleton selection component 214.

The skeleton selection component 214 selects one or multiple skeletons matching the target impression designated in the target impression designation component 204 among the skeletons obtained from the skeleton obtaining component 213, and outputs the selected skeletons to the layout component 217. Since the arrangement of the entire poster is determined by the skeleton, preparing various types of skeletons in advance can increase variety of generated posters.

The color scheme pattern selection component 215 obtains one or multiple color scheme patterns matching the target impression designated in the target impression designation component 204, from the HDD 104, and outputs the obtained color scheme pattern to the layout component 217. The color scheme pattern is a combination of colors to be used in the poster.

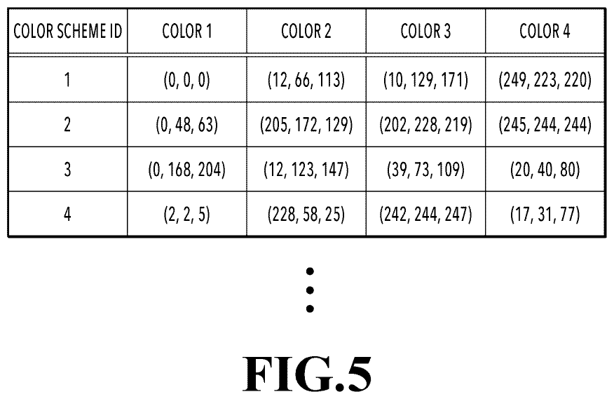

FIG. 5 is a diagram illustrating an example of a table of the color scheme patterns. In the present embodiment, each color scheme pattern is illustrated as a combination of four colors. The column of color scheme ID in FIG. 5 is an ID for uniquely identifying the color scheme pattern. Columns of color 1 to color 4 each illustrate a color value of each of R, G, and B in a value of 0 to 255 in the order of RGB ((R, G, B)=(0 to 255, 0 to 255, 0 to 255)). Although the color scheme pattern formed of the combination of four colors is used in the present embodiment, the number of colors may be another number, or multiple numbers of colors may coexist.

The font selection component 216 selects one or multiple font patterns matching the target impression designated in the target impression designation component 204, obtains the selected font patterns from the HDD 104, and outputs the font patterns to the layout component 217. The font patterns are each a combination of at least one of a font of the title, a font of the subtitle, and a font of the main text.

The layout component 217 lays out various pieces of data on each of the one or multiple skeletons obtained from the skeleton selection component 214, and generates one or multiple pieces of poster data as many as or more than the designated poster creation number by laying out the various pieces of data. The layout component 217 arranges the text obtained from the text designation component 202 and the image data obtained from the image analysis component 212 or the image selection component 222, on each skeleton. Moreover, the layout component 217 applies each color scheme pattern obtained from the color scheme pattern selection component 215, and applies each font pattern obtained from the font selection component. The layout component 217 outputs the generated one or multiple pieces of poster data to the poster impression estimation component 218.

The poster impression estimation component 218 estimates the impression of each of the multiple pieces of poster data obtained from the layout component 217, and associates the estimated impression with the piece of poster data. Then, the poster impression estimation component 218 outputs the one or multiple pieces of poster data associated with the estimated impression, to the poster selection component 219.

The poster selection component 219 compares the target impression designated in the target impression designation component 204 and each of the estimated impressions of the multiple pieces of poster data associated with the estimated impressions obtained from the poster impression estimation component 218, and selects the poster data associated with the estimated impression close to the target impression. The poster selection component 219 selects posters as many as or more than the creation number designated in the poster creation condition designation component 201. In this case, the poster selection component 219 selects posters as many as or more than the creation number, in ascending order of a value indicating a difference between the target impression and the estimated impression. The closeness between the target impression and the estimated impression is determined based on a difference of an impression value for each impression factor. The selection result is saved in the HDD 104. The poster selection component 219 outputs the selected poster data to the poster display component 205.

The poster display component 205 displays poster images based on the poster data obtained from the poster selection component 219, on the display 105. The poster images are, for example, bit map data. Note that, since the pieces of poster data as many as or more than the creation number designated in the poster creation condition designation component 201 are generated in the poster generation component 210, previews of the poster images are displayed on the display 105 as a list. In the case where the user clicks any of the poster images with the pointing device 107, the clicked poster image is set to a selected state.

Note that the poster creation application may be additionally provided with a function of further changing each poster to a design desired by the user after the display of the generation result in the poster display component 205 by editing the arrangement, the colors, the shapes, and the like of the image, the text, and the graphic by additional user operations. Moreover, providing a function of printing the poster data saved in the HDD 104 with a printer under a condition designated in the poster creation condition designation component 201 allows the user to obtain a print product of the created poster.

The image impression estimation component 221 and the image selection component 222 are software blocks used in the impression prioritized mode to be described later. The image impression estimation component 221 estimates the impression of each of one or multiple pieces of image data obtained from the image analysis component 212, and outputs the image data and the estimated impression to the image selection component 222.

The image selection component 222 is a software block used in the impression prioritized mode to be described later. The image selection component 222 selects one piece of image data in which the estimated impression associated with this piece of image data is closest to the target impression obtained from the target impression designation component 204, from the one or multiple pieces of image data obtained from the image impression estimation component 221, and outputs the selected piece of image data to the layout component 217. Note that the image selection component 222 executes the process in the impression prioritized mode that is the operation mode whose purpose is to further simplify the user operation from that in the content prioritized mode. Accordingly, the number of images selected by the image selection component 222 is limited to one to simplify subsequent processes. Note that multiple images may be selected depending on a creation condition such as the case where the user designates a number more than one as the number of images to be used in the poster.

### Example of Display Screen

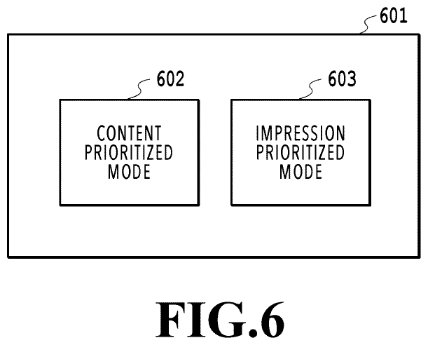

FIG. 6 is a diagram illustrating an example of a mode selection screen 601 provided by the poster creation application. The mode selection screen 601 is displayed on the display 105. The user sets the operation mode to be described later through the mode selection screen 601.

A content prioritized mode button 602 of the mode selection screen 601 is a button for setting the operation mode in the poster creation application to the content prioritized mode. In the case where the content prioritized mode button 602 is pressed, a content setting screen 701 illustrated in FIG. 7 is displayed on the display 105.

An impression prioritized mode button 603 of the mode selection screen 601 is a button for setting the operation mode in the poster creation application to the impression prioritized mode. In the case where the impression prioritized mode button 603 is pressed, a content setting screen for the impression prioritized mode is displayed on the display 105. Note that the content setting screen for the impression prioritized mode is displayed with a target impression range setting region 725 in FIG. 7 not displayed or displayed in a grayed-out state.

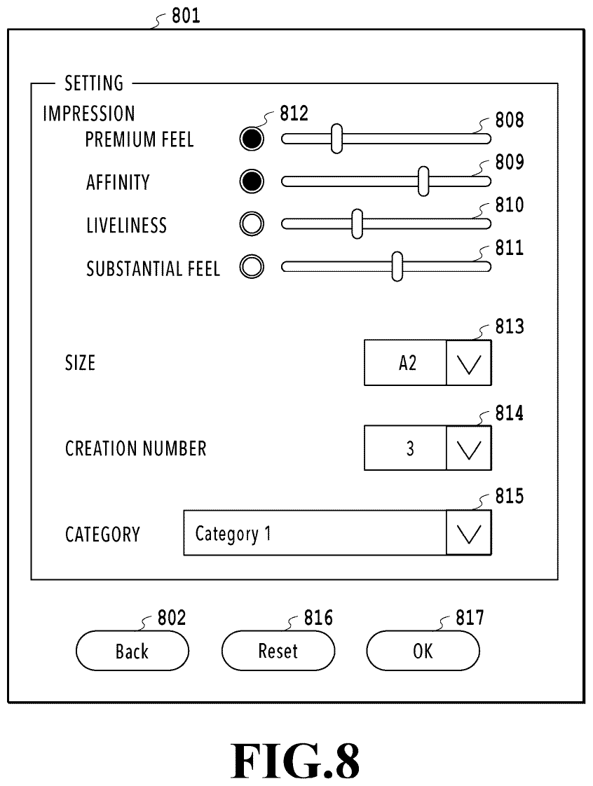

FIG. 7 is a diagram illustrating the content setting screen 701 provided by the poster creation application, and FIG. 8 is a diagram illustrating an example of a generation condition setting screen 801. The content setting screen 701 and the generation condition setting screen 801 are displayed on the display 105. The user designates a text and an image that are the contents to be arranged on the poster, the target impression of the poster to be created, and the creating conditions (size, creation number, and use application category) of the poster, through the content setting screen 701 and the generation condition setting screen 801. The poster creation condition designation component 201, the image designation component 203, and the text designation component 202 obtain contents of the designation from the user through these UI screens.

The content setting screen 701 is provided with a content input region 724 and the target impression range setting region 725.

A title box 702, a subtitle box 703, and a main text box 704 in the content input region 724 receives designation, by the user, of the character information to be arranged in the poster. Note that, although three types of character information are received in the present embodiment, the present disclosure is not limited to this. For example, character information such as location, time, and date may also be additionally received. Moreover, the character information does not have to be inputted into all boxes, and there may be a blank box.

An image designation region 705 in the content input region 724 is a region in which an image to be arranged in the poster is designated. An image 706 illustrates a thumbnail of the designated image. An image addition button 707 is a button for adding the image to be arranged in the poster. In the case where the user presses the image addition button 707, the image designation component 203 displays a dialog screen for selecting an image file, and receives image file selection by the user. Then, a thumbnail of the selected image is added to the image designation region 705.

The target impression range setting region 725 is provided with check boxes 718 and 719 that allow the user set the range change setting information. As described above, the range change setting information is information designating how the setting ranges of the target impression are to be determined. In the present embodiment, the user can designate one of “ranges suiting the image”, “ranges suiting the title”, ranges suiting both of the image and the title, and a default range.

The check box 718 is a box that enables execution of control of enabling or disabling a process of changing the setting ranges of the target impression to ranges suiting the image designated in the image designation region 705. The user can set whether to enable (on) or disable (off) the changing to the setting ranges of the target impression suiting the image by pressing the check box 718 and setting on/off.

The check box 719 is a box that enables execution of control of enabling or disabling of a process of changing the setting ranges of the target impression to ranges suiting the title designated in the title box 702. The user can set whether to enable (on) or disable (off) the changing to the setting ranges of the target impression suiting the title by pressing the check box 719 and setting on/off. Note that, although the changing suiting the title among the pieces of character information is performed in the present embodiment, the present disclosure is not limited to this, and changing suiting the subtitle or the main text may be performed. Moreover, in the case where both of the check box 718 and the check box 719 are set to on, changing to the setting ranges of the target impression based on both of the image and the title is enabled. Meanwhile, in the case where both of the check box 718 and the check box 719 are set to off, the setting ranges of the target impression are not changed, and the default setting range is applied. Note that, in the impression prioritized mode, the check boxes 718 and 719 are not displayed or set to be unselectable, and the default setting range is always applied.

A reset button 720 is a button for resetting the pieces of setting information on the content setting screen 701.

In the case where the user presses a next button 721, a displayed screen switches to the generation condition setting screen 801 of FIG. 8. Moreover, the poster creation condition designation component 201, the text designation component 202, and the image designation component 203 output the contents set on the content setting screen 701 to the poster generation component 210. In this case, the poster creation condition designation component 201 obtains the range change setting information from the check box 718 and the check box 719. Note that the range change setting information is information indicating one of four states of “no change (default range)”, “image”, “text”, and “image and text”. The image designation component 203 obtains a file path of the image to be arranged in the poster, from the image designation region 705. The text designation component 202 obtains the character information to be arranged in the poster from the title box 702, the subtitle box 703, and the main text box 704.

Impression sliders 808 to 811 of the generation condition setting screen 801 are each an operation object with which the user sets a value indicating a degree of the target impression of the poster to be created for a corresponding one of factors (hereinafter, referred to as impression factors) of the target impression. For example, the impression slider 808 is a slider for setting a value indicating a degree of the target impression for an impression factor “premium feel”. The target impression is set such that the further the impression slider 808 is slid to the right, the higher the impression of premium feel given by the poster is, and the further the impression slider 808 is slid to the left, the lower (cheaper) the impression of premium feel given by the poster is. Moreover, combining the factors of the target impression set in the respective sliders enables setting of a comprehensive target impression reflecting not only the impression factor set in one slider but also the impression factors set in the other sliders.

For example, in the case where the impression slider 808 corresponding to the impression factor “premium feel” is set on the right side of the center and the impression slider 811 corresponding to an impression factor “substantial feel” is set on the left side of the center, a poster with an elegant impression that has high premium feel and low substantial feel is generated. Moreover, for example, in the case where the impression slider 808 corresponding to the impression factor “premium feel” is set on the right side of the center and the impression slider 811 corresponding to the impression factor “substantial feel” is set on the right side of the center, a poster with a gorgeous impression that has high premium feel and high substantial feel is generated. Combining the factors of target impression indicated by the multiple impression sliders as described above enables setting of target impressions of various directions such as the “elegant” target impression and the “gorgeous” target impression even in the case where the factor “premium feel” of the target impression is commonly set to presence of “premium feel”.

Specifically, the target impression is formed of and determined by multiple factors indicating the impression. Note that the target impression may be determined by one factor indicating the impression. In the present embodiment, each of the values indicating the impression is assumed to be corrected to a value from −2 to +2 with −2 being a state where the slider set to the left-most position and +2 being a state where the slider is set to the right-most position. These numerical values are values indicating that −2 is low, −1 is slightly low, 0 is neither high nor low, +1 is slightly high, and +2 is high for the impression. Note that, purpose of correcting the value to a value from −2 to +2 is to match the value with a scale of the estimated impression and facilitate distance calculation to be described later. The present disclosure is not limited to this, and normalization may be performed by using a value from 0 to 1.

In the present embodiment, each of the ranges in which the user can perform operations in the impression sliders 808 to 811 is changed to the range determined in the target impression setting control component 220 in the case where at least one of the check box 718 and the check box 719 is set to on. Specifically, the setting range for each of the impression factors of the target impression is changed to the setting range suiting the image or the character information to be used in the poster. In other words, control is performed such that the setting ranges of the impression sliders 808 to 811 in the case where designation of a first content is received are different from those in the case where designation of a second content different from the first content is received. A method of determining the ranges of the target impression by the target impression setting control component 220 is described later.

Radio buttons 812 are buttons that enable execution of control of enabling or disabling setting of the respective impression factors. The user can set whether to enable or disable the setting of each impression factor by pressing a corresponding one of the radio buttons 812 and setting on/off. For example, in the case where off is selected in one of the radio buttons 812, the corresponding impression factor is excluded from the control of impression. For example, in the case where a calm poster with low liveliness is desired to be created and there is no particular designation for other impressions, the user can set the radio buttons 812 for the impression factors other than the liveliness to off to create a poster specialized in low liveliness. Note that FIG. 8 illustrates a state where premium feel and affinity are set to on, and liveliness and substantial feel are set to off. This enables control with high flexibility in which all impression factors are used for the poster generation or only some of the impression factors are used for the poster generation. Note that, in the case where a state in which each of the sliders is set to the left-most position is considered to be the same as a state in which a corresponding one of the impression factors is not set, a configuration provided with no radio buttons 812 may be employed. In this case, in the case where the setting of each impression factor is to be disabled, the user can disable the setting of the impression factor by setting the corresponding slider to the left-most position.

A size list box 813 is a list box for setting the size of the poster to be created. The user can perform a click operation with the pointing device 107 to display a list of creatable poster sizes and select a poster size. The number of candidates of the poster to be created can be set in a creation number box 814. The use application category of the poster to be created can be set in a category list box 815.

A back button 802 is a button for returning to the content setting screen 701. A reset button 816 is a button for resetting the pieces of setting information on the generation condition setting screen 801.

In the case where the user presses an OK button 817, the poster creation condition designation component 201 and the target impression designation component 204 output the information set on the generation condition setting screen 801, to the poster generation component 210. In this case, the poster creation condition designation component 201 obtains the size of the poster to be created from the size list box 813, obtains the number of posters to be created from the creation number box 814, and obtains the use application category of the poster to be created from the category list box 815. The target impression designation component 204 obtains the target impression of the poster to be created from the impression sliders 808 to 811 and the radio buttons 812. Note that the poster creation condition designation component 201, the text designation component 202, the image designation component 203, and the target impression designation component 204 may process the values set in the content setting screen 701. For example, the text designation component 202 may remove unnecessary whitespace characters at a head or an end of the inputted character information, from the character information. Moreover, the target impression designation component 204 may correct the values of the target impression designated in the impression sliders 808 to 811.

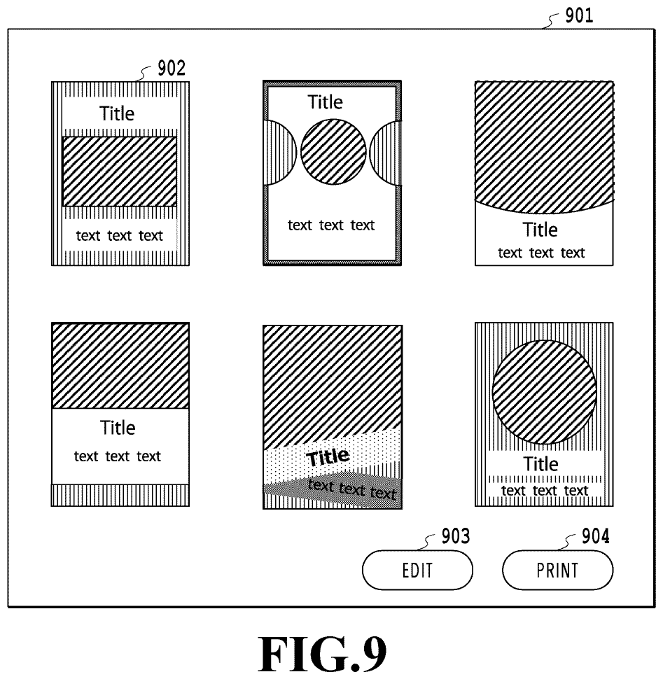

FIG. 9 is a diagram illustrating an example of a poster preview screen 901 in which generated poster images 902 are displayed on the display 105 by the poster display component 205. In the case where the OK button 817 of the generation condition setting screen 801 is pressed and the poster generation is completed, the screen displayed on the display 105 transitions to the poster preview screen 901.

The poster images 902 are poster images outputted by the poster display component 205. Since the pieces of poster data as many as or more than the creation number designated in the poster creation condition designation component 201 are generated in the poster generation component 210, poster images 902 as many as the number of generated pieces of poster data are displayed as a list. In the case where the user clicks one of the poster images 902 with the pointing device 107, the poster data corresponding to the clicked poster image 902 is set to a selected state.

An edit button 903 is a button for transition to a function of editing the poster data set to the selected state. In the edit function, editing of the poster data can be performed through a not-illustrated UI.

A print button 904 is a button for transition to a function of printing the poster data set to the selected state. In the print function, the poster data can be printed through a not-illustrated control UI of a printer.

### Poster Impression Quantification

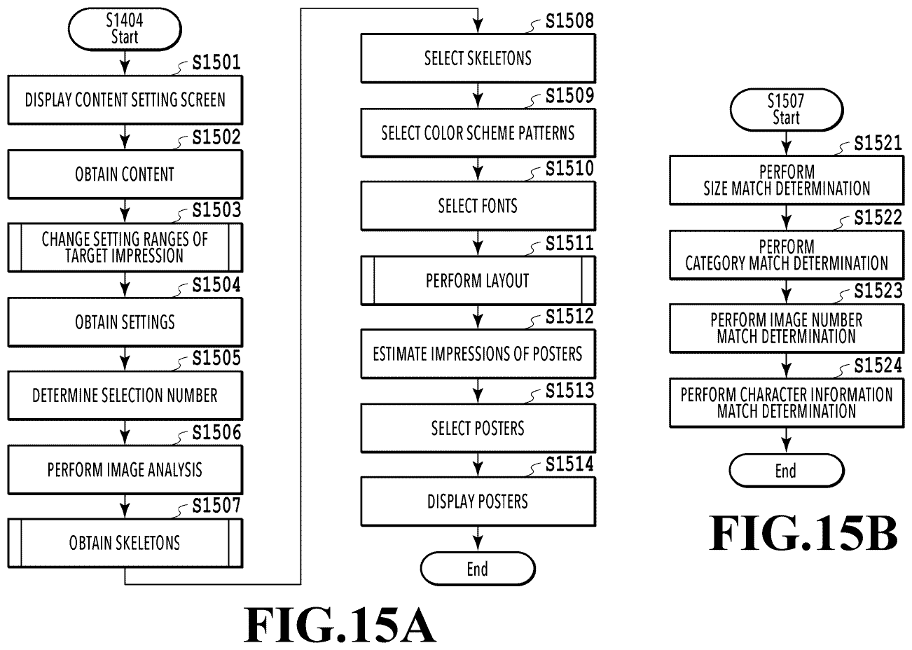

A process (hereinafter, referred to as poster impression quantification process) of quantifying the impression of each poster is explained. The poster impression quantification process is a preliminary process necessary for execution of a poster impression estimation process (S1512 of FIG. 15A) to be described later. The poster impression estimation process is executed in the poster generation process (FIGS. 15A and 15B) to be described later.

The poster impression quantification process is performed in a development stage of the poster creation application by a vendor or the like developing the poster creation application. Note that the poster impression quantification process may be executed in the poster generation apparatus 100 or in an information processing apparatus different from the poster generation apparatus 100. Note that, in the case where the poster impression quantification process is executed in the information processing apparatus different from the poster generation apparatus 100, the poster impression quantification process is executed by a CPU of the information processing apparatus.

In the poster impression quantification process, impressions felt by a person for various posters are quantified. Simultaneously, correspondence relationships between the poster images and the impressions of the posters are derived. This allows the impression of the poster to be estimated from the generated poster image. In the case where the estimation of the impression is possible, it is possible to control the impression of the poster by correcting the poster image or to search for the poster image that gives a certain target impression. Note that the poster impression quantification process is executed by, for example, operating an impression learning application for learning the impressions of the poster images in advance in the poster generation apparatus before the poster generation process.

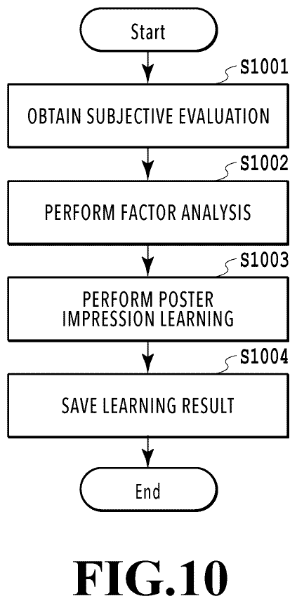

FIG. 10 is a flowchart illustrating the poster impression quantification process. For example, the CPU 101 implements the flowchart illustrated in FIG. 10 by reading out programs stored in the HDD 104 to the RAM 103 and executing the programs. The poster impression quantification process is explained with reference to FIG. 10. Note that sign “S” in explanation of each process means step in the flowchart (the same applies below in the present specification).

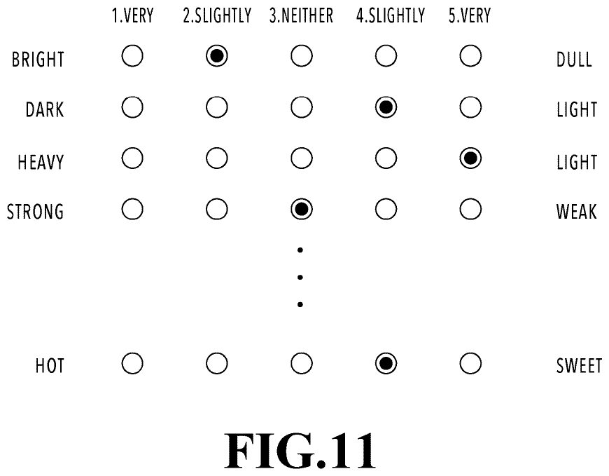

In S1001, the CPU 101 obtains a subjective evaluation of the impression of each poster. FIG. 11 is a diagram explaining an example of a subjective evaluation method of the impression of the poster. The CPU 101 presents the poster to a trial subject, and obtains, from the trial subject, the subjective evaluation of the impression received from the poster. In this case, a measurement method such as a semantic differential (SD) method or a Likert scale method can be used. FIG. 11 illustrates an example of a questionnaire that uses the SD method and in which the pairs of adjectives representing impressions are presented to the user and scoring is performed for the pairs of adjectives given by the target poster. The CPU 101 obtains subjective evaluation results of multiple posters from the multiple trial subjects, determines an average value of answers for each pair of adjectives, and sets the average value as a representative score of the corresponding pair of adjectives. Note that the subjective evaluation method of the impression may be a method other than the SD method, and it is only necessary that a word expressing the impression and a score corresponding to this word are determined.

In S1002, the CPU 101 executes factor analysis of each of the subjective evaluation results obtained in S1001. In the case where the subjective evaluation result is used as it is, the number of the pairs of adjectives is equal to the number of dimensions, and the control is complex. Accordingly, it is desirable to reduce the number of dimensions to an efficient number of dimensions by using an analysis method such as principal component analysis or factor analysis. In the present embodiment, explanation is given assuming that the dimensions are reduced to four factors by the factor analysis. As a matter of course, this number may change depending on the selection of the pairs of adjectives in the subjective evaluation and the factor analysis method. Moreover, an output of the factor analysis is assumed to be standardized. Specifically, each factor is scaled such that a mean is 0 and a variance is 1 in the poster used in the analysis. This allows −2, −1, 0, +1, and +2 of the impression designated in the target impression designation component 204 to directly correspond to −2σ, −1σ, a mean value, +1σ, and +2σ in each impression, and calculation of the distance between the target impression and the estimated impression to be described later is facilitated. Note that, although the premium feel, affinity, liveliness, and substantial feel illustrated in FIG. 8 are described as the four factors in the present embodiment, these names are names given for the sake of convenience to convey the impressions to the user through the user interface, and each factor is formed of multiple pairs of adjectives influencing one another. Moreover, the CPU 101 saves a formula (hereinafter, referred to as “impression conversion formula”) for conversion from the subjective evaluation results of the respective pairs of adjectives obtained by the factor analysis to the values of the respective impressions, in the HDD 104.

In S1003, the CPU 101 associates the poster image and the impression with each other. Although the quantification can be performed on the poster subjected to the subjective evaluation in the above-mentioned method, the estimation of the impression needs to be performed also for a poster to be created from here on without the subjective evaluation. The association of the poster image and the impression can be implemented by training a model that estimates the impression from the poster image. Specifically, for example, a deep learning method using convolution neural network (CNN) or visual transformer (ViT), a machine learning method using a decision tree, or the like can be used. In the present embodiment, the CPU 101 performs supervised deep learning using CNN with the poster image being an input and the four factors being an output. Specifically, the CPU 101 creates a deep learning model by performing training with the poster image subjected to the subjective evaluation and the corresponding impression being correct answers, and inputs an unknown poster image into this learning model to estimate the impression.

In S1004, the CPU 101 saves a model configuration and trained parameters of the deep learning model for impression estimation created in S1003, in the HDD 104.

The poster impression estimation component 218 expands the deep learning model saved in the HDD 104 on the RAM 103, and executes the deep learning model. The poster impression estimation component 218 forms an image of the poster data obtained from the layout component 217, and estimates the impression of the poster by causing the deep learning model expanded on the RAM 103 to operate with the CPU 101 or the GPU 109. Note that, although the deep learning method is used in the present embodiment, the present disclosure is not limited to this. For example, in the case where the machine learning method such as the decision tree is used, there may be created a machine learning model that extracts feature amounts such as a brightness average value, an edge amount, and the like of the poster image by performing image analysis and that estimates the impression based on these feature amounts.

### Content Impression Quantification

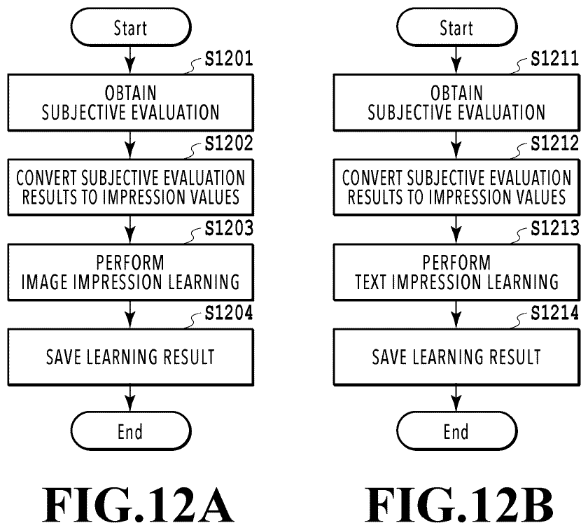

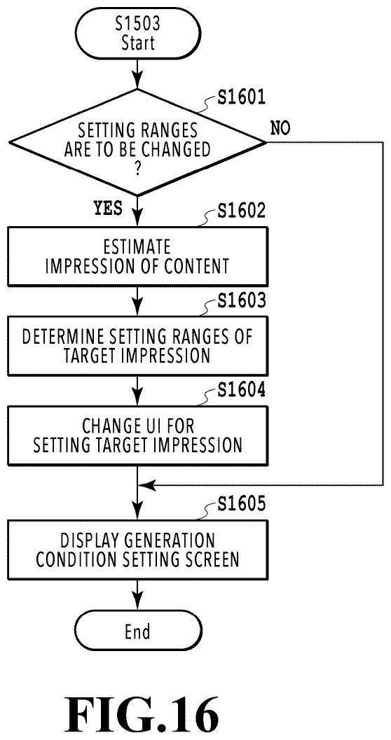

Next, a process (hereinafter, referred to as content impression quantification process) of quantifying the impression of each content is explained with reference to FIGS. 12A and 12B. The content impression quantification process is a preliminary process for executing a content impression estimation process (S1602 of FIG. 16). The content impression estimation process is executed in a process of changing the setting ranges of the target impression (S1503 of FIG. 15A) in the poster generation process to be described later. The content impression quantification process is performed in a development stage of the poster creation application by the vendor or the like developing the poster creation application. Note that the content impression quantification process may be executed in the poster generation apparatus 100 or in an information processing apparatus different from the poster generation apparatus 100. Note that, in the case where the content impression quantification process is executed in the information processing apparatus different from the poster generation apparatus 100, the content impression quantification process is executed by a CPU of the information processing apparatus.

In the content impression quantification process, there is derived a correspondence relationship between the content itself and the impression of the content in a space in which the impression of the poster is quantified. This enables searching of the content suiting the impression of the poster desired to be generated. Note that the content impression quantification process is executed by, for example, causing an impression learning application for learning the impression of the content to operate in advance in the poster generation apparatus before the poster generation process. Moreover, since the content impression quantification process uses the impression conversion formula obtained in the poster impression quantification process illustrated in FIG. 10, the content impression quantification process needs to be executed after the poster impression quantification process.

FIGS. 12A and 12B are flowcharts illustrating the content impression quantification process. For example, the CPU 101 implements the flowcharts illustrated in FIGS. 12A and 12B by reading out programs stored in the HDD 104 to the RAM 103 and executing the programs. First, an image impression quantification process is explained with reference to FIG. 12A.

In S1201, the CPU 101 obtains a subjective evaluation of the impression of each image. A method similar to the method of the subjective evaluation executed in the poster impression quantification process may be performed for the subjective evaluation. After obtaining subjective evaluation results of multiple images from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1202, the CPU 101 obtains the impression conversion formula obtained in the factor analysis performed in the poster impression quantification process, from the HDD 104, and applies the impression conversion formula to each of the subjective evaluation results obtained in S1201 to obtain impression values of each image. Applying the impression conversion formula obtained in the poster impression quantification process allows the impression of the image to be quantified on dimensions having the same meaning as the impression of the poster.

In S1203, the CPU 101 associates the image and the impression with each other. Although the quantification can be performed on the image subjected to the subjective evaluation in the above-mentioned method, the estimation of the impression needs to be performed also for an unknown image without the subjective evaluation, in the poster generation process of the present embodiment. The association of the image and the impression can be implemented by training a model that estimates the impression from the image. Specifically, for example, a deep learning method using convolution neural network (CNN) or visual transformer (ViT), a machine learning method using a decision tree, or the like can be used. In the present embodiment, the CPU 101 performs supervised deep learning using CNN with the image being an input and the four factors being an output. Specifically, the CPU 101 creates a deep learning model by performing training with the image subjected to the subjective evaluation and the corresponding impression being correct answers, and inputs an unknown image into this learning model to estimate the impression.

In S1204, the CPU 101 saves a model configuration and trained parameters of the deep learning model for impression estimation created in S1203, in the HDD 104.

Next, a text impression quantification process is explained with reference to FIG. 12B.

In S1211, the CPU 101 obtains a subjective evaluation of the impression of each text. A method similar to the method of the subjective evaluation executed in the poster impression quantification process may be performed for the subjective evaluation. After obtaining subjective evaluation results of multiple texts from multiple trial subjects, the CPU 101 determines an average value of answers for each pair of adjectives, and sets the average value as a representative score of the corresponding pair of adjectives. Note that the subjective evaluation method of the impression may be a method other than the SD method, and it is only necessary that a word representing the impression and a score corresponding to this word are determined.

In S1212, the CPU 101 obtains the impression conversion formula obtained in the factor analysis performed in the poster impression quantification process, from the HDD 104, and applies the impression conversion formula to each of the subjective evaluation results obtained in S1211 to obtain impression values of each text. Applying the impression conversion formula obtained in the poster impression quantification process allows the impression of the text to be quantified on dimensions having the same meaning as the impression of the poster.

In S1213, the CPU 101 associates the text and the impression with each other. Although the quantification can be performed on the text subjected to the subjective evaluation in the above-mentioned method, the estimation of the impression needs to be performed also for an unknown text without the subjective evaluation. The association of the text and the impression can be implemented by using, for example, a deep learning method using Transformer, a machine learning method using a decision tree, or the like to train a model that estimates the impression from the text. In the present embodiment, the CPU 101 performs supervised deep learning using Transformer with the text being an input and the four factors being an output. Specifically, the CPU 101 creates a deep learning model by performing training with the text subjected to the subjective evaluation and the corresponding impression being correct answers, and inputs an unknown text into this learning model to estimate the impression.

In S1214, the CPU 101 saves a model configuration and trained parameters of the deep learning model for impression estimation created in S1213, in the HDD 104.

### Explanation of Operation Mode

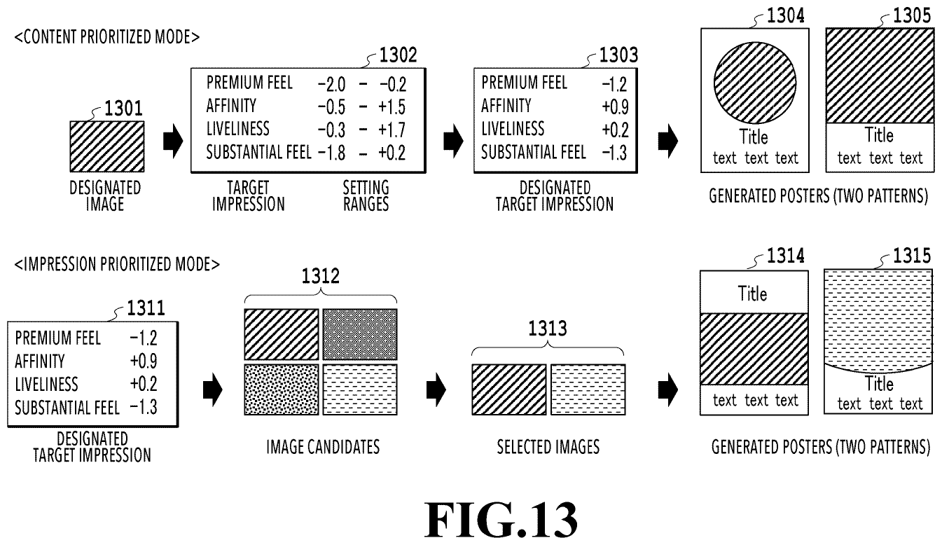

Explanation is given of an outline of differences of the process flows in the content prioritized mode and the impression prioritized mode that are the operation modes of the poster creation application and differences of the posters outputted in these modes, with reference to FIG. 13. Note that, although the case where the content used in the posters is the image is given as the example in FIG. 13, the character information such as the title can be also handled as the content in the present embodiment.

The content prioritized mode is a mode in which the UI for setting the target impression is changed such that a target impression suiting the content to be used in the poster is prioritized. A process flow is as follows. First, the poster creation application receives designation of a content 1301 to be used in the poster, from the user. Next, the poster creation application determines setting ranges 1302 of the target impression suiting the designated content 1301. Then, the poster creation application receives designation of a target impression by the user within the determined setting ranges 1302 of the target impression. The designated target impression is denoted by reference numeral 1303 in FIG. 13. The poster creation application generates posters 1304 and 1305 having impressions close to the designated target impression 1303 by using the designated content 1301. In the case where posters of multiple patterns are generated, the designated content 1301 is used in all posters.

The impression prioritized mode is a mode in which a content suiting the target impression designated by the user is automatically selected. A process flow is as follows. First, the poster creation application receives designation of a target impression 1311 by the user. Next, the poster creation application receives designation, by the user, of candidates 1312 of a content to be used in the poster. In the designation of the candidates of the content, candidates of the title are inputted by the user. The user may designate a specific image as a candidate of the image, or designate a directory, a tag, or an application material image itself to designate images associated with the directory, the tag, or the application material image as the candidates of the image in a batch. The poster creation application selects contents 1313 suiting the designated target impression 1311 from the candidates 1312 of contents. The poster creation application generates posters 1314 and 1315 having impressions close to the target impression by using the selected contents 1313. In the case where posters of multiple patterns are generated, contents of varying patterns may be used in the respective posters.

As described above, in the content prioritized mode, the designation of the content by the user is the starting point of the process. Meanwhile, in the impression prioritized mode, the designation of the target impression by the user is the starting point of the process. Moreover, in the content prioritized mode, the content designated by the user is certainly used in the generated posters. Meanwhile, in the impression prioritized mode, varying contents may be used in the generated posters depending on the target impression designated by the user. The user can cause the poster generation process to be executed in a creation flow as intended, by selecting one of these operation modes.

### Operation Mode Switching Process

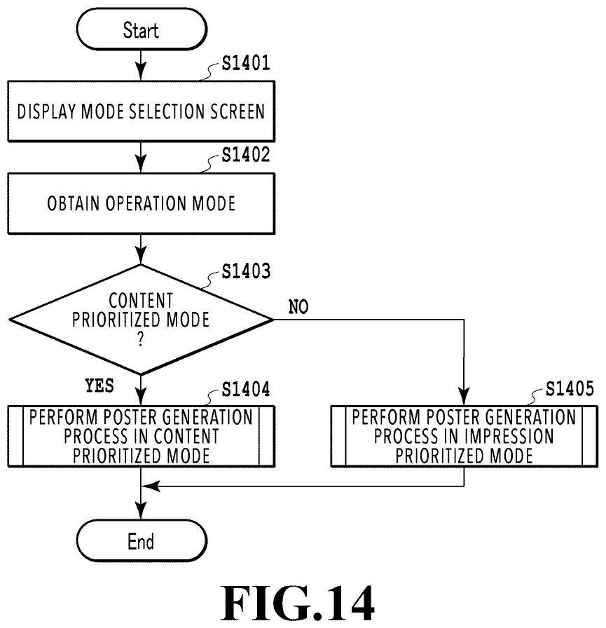

FIG. 14 is a flowchart illustrating an operation mode switching process of the poster creation application. The flowchart illustrated in FIG. 14 is started in the case where the poster creation application is activated by a user operation.

For example, the CPU 101 implements the flowchart illustrated in FIG. 14 by reading out programs stored in the HDD 104 to the RAM 103 and executing the programs. In the present embodiment, explanation is given assuming that the process is executed by the components that are illustrated in FIG. 2 and that function by execution of the above-mentioned poster creation application by the CPU 101. The operation mode switching process is explained with reference to FIG. 14. Note that sign “S” in explanation of each process means step in this flowchart (the same applies below in the present specification).

In S1401, the poster creation application displays the mode selection screen 601 on the display 105. The user designates one of the operation modes displayed in the mode selection screen 601, with the pointing device 107.

In S1402, the operation mode designation component 230 obtains the operation mode designated in the mode selection screen 601.

In S1403, the operation mode designation component 230 determines whether the operation mode obtained in S1402 is the content prioritized mode or the impression prioritized mode. In the case where the operation mode is the content prioritized mode, the process transitions to S1404. In the case where the operation mode is the impression prioritized mode, the process transitions to S1405.

In S1404, the poster generation component 210 executes the poster generation process in the content prioritized mode.

In S1405, the poster generation component 210 executes the poster generation process in the impression prioritized mode.

The process flow of the poster creation application has been described above. Details of the poster generation process in the content prioritized mode executed in S1404 and the poster generation process in the impression prioritized mode executed in S1405 are explained below.

### Poster Generation Process in Content Prioritized Mode

FIGS. 15A and 15B are flowcharts illustrating the poster generation process in the content prioritized mode. The flowcharts illustrated in FIGS. 15A and 15B are started in the case where the content prioritized mode is selected in the operation mode switching process described above. For example, the CPU 101 implements the flowcharts illustrated in FIGS. 15A and 15B by reading out programs stored in the HDD 104 onto the RAM 103 and executing the programs. In the present embodiment, explanation is given assuming that the process is executed by the components that are illustrated in FIG. 2 and that function by execution of the above-mentioned poster creation application by the CPU 101. Note that, in the content prioritized mode, the image impression estimation component 221 and the image selection component 222 in FIG. 2 are not used. The poster generation process in the content prioritized mode is explained with reference to FIGS. 15A and 15B.

In S1501, the poster creation application displays the content setting screen 701 illustrated in FIG. 7, on the display 105.

In S1502, the text designation component 202 and the image designation component 203 receive the designation of text or the designation of image by the user for each of setting items displayed in the content setting screen 701. The user inputs a setting value of each setting item by using the keyboard 106 and the pointing device 107. The image obtaining component 211 obtains the image data. Specifically, the image obtaining component 211 reads out the image file from the obtaining destination (for example, HDD 104) designated in the image designation component 203 to the RAM 103. Moreover, the CPU 101 obtains the character information inputted in the title box 702, the subtitle box 703, and the main text box 704.

In S1503, the target impression setting control component 220 executes the process of changing the setting ranges of the target impression designatable by the user, based on the contents (image and character information) obtained in S1502. In the process of changing the setting ranges of the target impression, the target impression setting control component 220 determines the setting ranges of the target impression depending on the contents (image and character information), and displays the generation condition setting screen 801 including the UI in which the setting ranges are changed to the determined setting ranges, on the display 105.

### Process of Changing Setting Ranges of Target Impression

The process of changing the setting ranges of the target impression executed in S1503 is explained in detail by using FIG. 16. FIG. 16 is a flowchart for explaining the process of S1503 in detail, and is executed by the determination component 301, the content impression estimation component 302, the setting range determination component 303, and the UI changing component 304 of the target impression setting control component 220 illustrated in FIG. 3.

In S1601, the determination component 301 determines whether the setting ranges of the target impression are to be changed or not, based on the range change setting information obtained from the poster creation condition designation component 201. The range change setting information is designated by the user through the check boxes 718 and 719 of the target impression range setting region 725 in the content setting screen 701. In the case where the range change setting information is “no change” (S1601; NO), the determination component 301 causes the process to transition to S1605 with the setting ranges of the target impression maintained at the default setting range (reference range). In the present embodiment, the default setting range (reference range) is assumed to be a range of −2 or more and +2 or less for each impression. In the case where the range change setting information is information other than “no change” (S1601; YES), the process transitions to S1602.

In S1602, the content impression estimation component 302 estimates the impression of the content by using the trained model generated by the content impression quantification process illustrated in FIGS. 12A and 12B. In this case, in the case where the range change setting information is “image” or “image and text”, the content impression estimation component 302 estimates the impression of the image data obtained in the image obtaining component 211. Meanwhile, in the case where the range change setting information is the “text” or the “image and text”, the content impression estimation component 302 estimates the impression of the title obtained in the text designation component 202.

In S1603, the setting range determination component 303 determines the setting ranges of the target impression based on the impression of the content obtained in S1602. The setting range determination component 303 determines the setting ranges of the target impression such that the changed setting ranges are smaller than the above-mentioned default setting range (reference range). Moreover, the setting range determination component 303 determines the setting ranges of the target impression such that the changed setting ranges are ranges including the impression values estimated from the content. The setting ranges of the target impression suiting the content designated by the user are determined. As a result, the setting ranges (first range) determined in the case where the designation of a first content is received are different from the setting ranges (second range) determined in the case where the designation of a second content different from the first content is received.

In S1604, the UI changing component 304 changes ranges in which the impression sliders 808 to 811 being the UI (operation object) on the generation condition setting screen 801 can be set, based on the setting ranges of the target impression determined in S1603.

Thereafter, in S1605, the target impression setting control component 220 displays the generation condition setting screen 801 including the UI (operation object) in which the setting ranges of the target impression are changed to the setting ranges determined in S1601 to S1604. In the case where the process of S1605 is completed, the present flowchart is terminated, and the process proceeds to S1504 of FIG. 15A.

### Determination of Setting Ranges of Target Impression

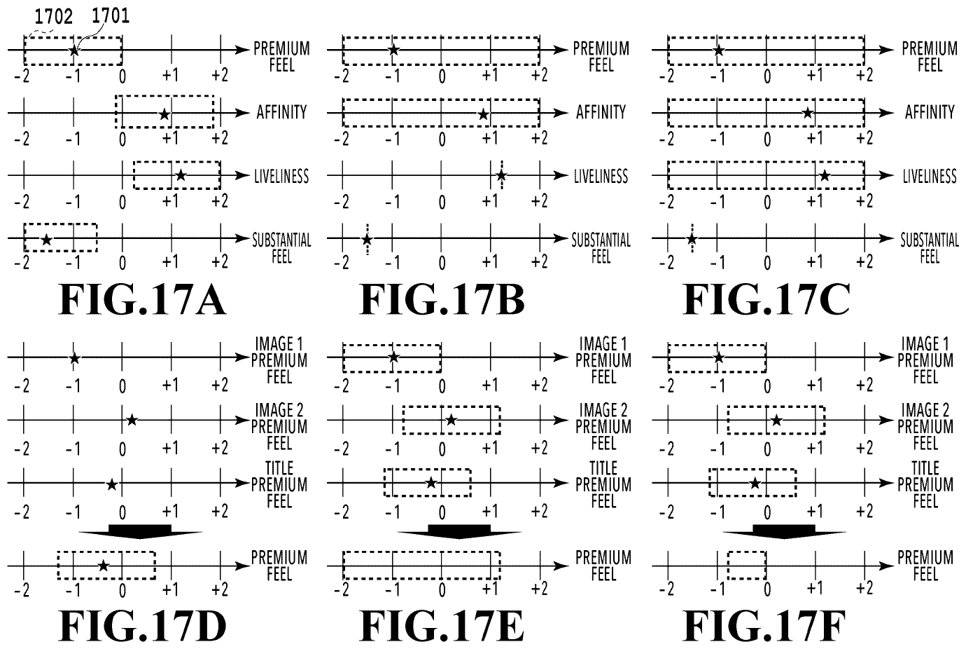

A method of determining the setting ranges of the target impression is explained with reference to FIGS. 17A to 17F. FIGS. 17A to 17F are diagrams illustrating the impression values of the content estimated in the content impression estimation process of S1602 and the setting ranges determined in S1603. Note that FIGS. 17A to 17F illustrate the impression value and the setting range for each of premium feel, affinity, liveliness, and substantial feel that are the impression factors. Star symbols 1701 in FIGS. 17A to 17F represent the impression values of the content estimated in the content impression estimation process of S1602, and broken line ranges 1702 represent the setting ranges. In the present embodiment, the setting range determination component 303 of the target impression setting control component 220 determines the setting range to be a range of +1 about the impression value of the content for each of the impression factors. Note that in the case where a value obtained by adding +1 or −1 to the impression value is outside the default setting range (reference range), the setting range is clipped to the default setting range (reference range). For example, in the example illustrated in FIG. 17A, the impression values of the content are premium feel −1.0, affinity +0.9, liveliness +1.2, and substantial feel −1.5. In this case, the setting ranges obtained in S1603 are −2.0 or more and 0.0 or less for premium feel, −0.1 or more and +1.9 or less for affinity, +0.2 or more and +2.0 or less (clipped to an upper limit value) for liveliness, and −2.0 or more and −0.5 or less (clipped to a lower limit value) for substantial feel. Note that the default setting range is assumed to be −2.0 or more and +2.0 or less.

Note that the method of determining the setting ranges is not limited to this. For example, the method may be such that the CPU 101 performs clustering on the impression values obtained in the content impression quantification process and saves a range of each of clusters, and the setting range determination component 303 sets the ranges of the clusters including the impression values obtained in S1602, as the setting ranges. Moreover, the method may be such that the CPU 101 obtains a result of a subjective evaluation test of determining a range in which a viewer seems to have the same impression for multiple contents, and the setting range determination component 303 determines the setting ranges based on the obtained result of the subjective evaluation test. In any case, the method of determining the setting ranges may be any method as long as the changed setting ranges are determined to be ranges that include the impression values estimated from the content and that are smaller than the setting range (reference range) of the target impression in the case where the range change setting information is “no change”.

Moreover, although the setting range is set to the range of “impression value +1” about the impression value of the content for each of the impression factors in the example of FIG. 17A, new setting ranges do not have to be set for all impression factors. For example, the configuration may be such that the setting range is fixed to one point for a characteristic impression factor in the impression of the content, and the default setting range (reference range) is set for the other impression factors. A method of determining the characteristic impression factor may be such that, for example, an impression factor in which an absolute value of the impression value is a value equal to or more than a predetermined threshold is set as the characteristic impression factor. An example of this case is illustrated in FIG. 17B. In the case where the impression values of the content are premium feel −1.0, affinity +0.9, liveliness +1.2, and substantial feel −1.5 and the predetermined threshold is 1.2, in S1603, the setting range determination component 303 determines that liveliness and substantial feel are the characteristic impression factors. Then, the setting range determination component 303 determines the setting ranges of the target impression such that the setting range of liveliness is fixed at +1.2, the setting range of substantial feel is fixed at −1.5, and the setting ranges of premium feel and affinity are −2.0 or more and +2.0 or less that is the normal setting range.

Moreover, the method of determining the characteristic impression factor may be such that the impression factor in which the absolute value is the largest among the impression factors of the content is set as the characteristic impression factor. An example of this case is illustrated in FIG. 17C. The impression values of the content are assumed to be premium feel −1.0, affinity +0.9, liveliness +1.2, and substantial feel −1.5. In this case, in S1603, the setting range determination component 303 determines substantial feel that is the impression factor in which the absolute value is the largest, as the characteristic impression factor. Then, the setting range determination component 303 determines the setting ranges of the target impression such that the setting range of substantial feel is fixed at −1.5 and the setting ranges of premium feel, affinity, and liveliness are −2.0 or more and +2.0 or less that is the normal setting range.

Moreover, the configuration may be such that the setting range of the characteristic impression factor is fixed at one point while the setting ranges of the other impression factors are each set to the range of ±1 about the impression value of the content.

Fixing the setting range of the target impression to one point for the characteristic impression factor determined based on the impression estimated from the content as described above also enables determination of the setting ranges of the target impression suiting the impression of the content.

Meanwhile, in the case where the impressions of the multiple images are estimated or the impressions of both of the image and the text are estimated in the content impression estimation process of S1602, as illustrated in FIG. 17D, the impression values are obtained for each of the multiple contents. In the case where the impression values are obtained for the multiple contents, for each impression factor, the setting range determination component 303 determines an average value of the impression values of all contents, and sets this average value as a representative impression value of all contents. Then, the setting range may be determined in the methods of FIGS. 17A to 17C described above. Note that, although the average value of the impression values of all contents is used as the representative impression value in the example of FIG. 17D, the present disclosure is not limited to this. For example, as illustrated in FIG. 17E, for each of the impression factors, the setting range determination component 303 determines the setting ranges, respectively, for the impression values of the contents obtained in the content impression estimation process of S1602, in the methods of FIGS. 17A to 17C. Then, the setting range determination component 303 may determine a union range of the determined setting ranges of all contents as the setting range. In this case, the setting range determination component 303 can determine a setting range in which a target impression suiting at least one of the impressions of the contents can be set.

Alternatively, as illustrated in FIG. 17F, for each impression factor, the setting range determination component 303 determines the setting ranges, respectively, for the impression values of the contents obtained in the content impression estimation process of S1602, in the methods of FIGS. 17A to 17C. Then, the setting range determination component 303 may set an intersection range of the determined setting ranges of all contents as the setting range. In this case, a range of impression common to the impressions of all contents can be set as the setting range. Note that, in this case, there may occur a situation where the intersection range is absent and no setting range is outputted in S1603. Measures in the case of no setting range are described later. Moreover, the configuration may be such that, in the case where multiple images are designated, one image designated first is set as a representative image, and the setting range is determined in the methods of FIGS. 17A to 17C by using only the impression of the representative image.

### UI Change depending on Setting Ranges of Target Impression

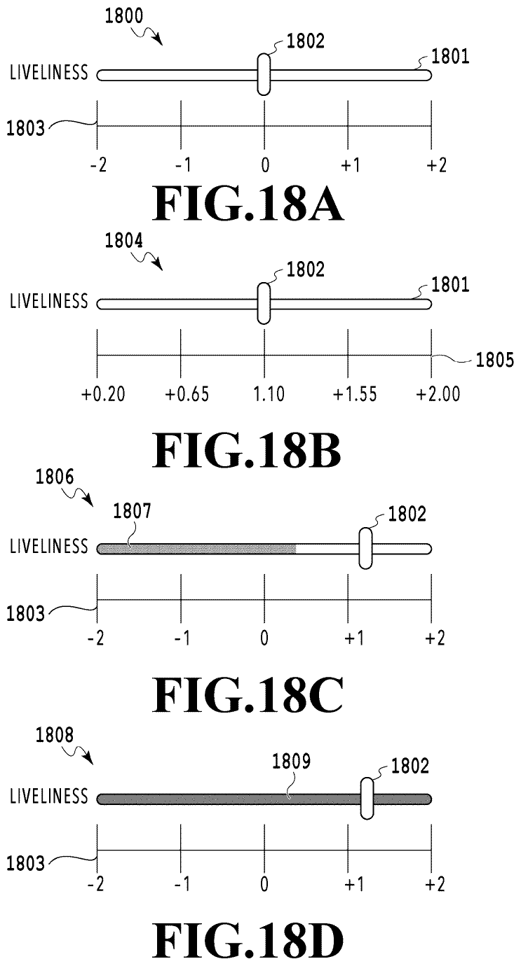

Next, the UI change (S1604) depending on the setting ranges of the target impression is explained with reference to FIGS. 18A to 18D. FIGS. 18A to 18D are diagrams illustrating change examples of the impression sliders 808 to 811 displayed on the generation condition setting screen 801 of FIG. 8. As illustrated in FIG. 18A, an impression slider 1800 is provided with a handle 1802 movable along a bar 1801. Moreover, a scale 1803 is displayed in the bar 1801, and an upper limit value and a lower limit value of the scale 1803 are set to the upper limit value and the lower limit value corresponding to the setting range.

The impression slider 1800 having the normal (default) setting range (reference range) illustrated in FIG. 18A is depicted such that a state where the handle 1802 is set at the left-most position is −2 that is the lower limit value and a state where the handle 1802 is set at the right-most position is +2 that is the upper limit value.

In the examples illustrated in FIGS. 18A and 18B, the UI changing component 304 sets the target impression value in the state where the handle 1802 is set at the left-most position to the lower limit value of the setting range, and sets the target impression value in the state where the handle 1802 is set at the right-most position to the upper limit value of the setting range. For example, FIG. 18B illustrates an impression slider 1804 in the case where the impression value of liveliness estimated from the content is +1.2 and the setting range of liveliness is set to +0.2 or more and +2.0 or less. The UI changing component 304 sets the target impression value in the state where the handle 1802 is set at the left-most position to +0.2, and sets the target impression value in the state where the handle 1802 is set at the right-most position to +2.0. A scale 1805 of the impression slider 1804 and the target impression value designated by the handle 1802 are determined from values set at the left end and the right end by ratio calculation. In this case, the UI changing component 304 may set an initial position of the handle 1802 at a position corresponding to the impression value of the content.

Note that the UI change method depending on the setting range is not limited to this. As illustrated in FIG. 18C, the UI changing component 304 may limit the movable range of the handle 1802 to the setting range determined by the setting range determination component 303 with the scale 1803 of an impression slider 1806 maintained at the default range (reference range). In this case, the UI changing component 304 may perform control of explicitly displaying a region outside the setting range in the impression slider, for example, displaying a gray region 1807 illustrated in FIG. 18C and preventing the handle 1802 from moving to the region outside the setting range. Moreover, the UI changing component 304 may set the initial position of the slider to a position corresponding to the impression value of the content.

Furthermore, as another example, in the case where there is an impression factor fixed at one point in the setting range determined by the setting range determination component 303, as illustrated in FIG. 18D, the UI changing component 304 may set an impression slider 1808 corresponding to the fixed impression factor to an inoperable state. In the example of FIG. 18D, the position of the handle 1802 is fixed at a position corresponding to the impression value of the content, and a region other than this position is illustrated as a gray region 1809.

Moreover, in the case where the user designates a value outside the setting range determined by the setting range determination component 303, the target impression setting control component 220 may display a not-illustrate warning screen. In the warning screen, information that the target impression value designated by the user is not suitable for the content may be displayed to prompt the user to redesignate the target impression.

As described above, in the examples of FIGS. 18A to 18D of the present embodiment, the setting range of the target impression is displayed in the generation condition setting screen 801, and the user can recognize the range of the target impression designatable (settable) by the user.

Moreover, the UI changing component 304 may set on/off of the radio buttons 812 provided near the sliders depending on the setting ranges determined by the setting range determination component 303 without changing the operable ranges of the sliders from the default range (reference range). For example, the configuration may be such that, in the case where the setting range of a certain impression factor is larger than a predetermined range in the setting ranges of the target impression determined by the setting range determination component 303, the radio button 812 of the certain impression factor is set to off, and the radio buttons 812 of the other impression factors are set to on. This is due to the following reason. If the setting range of the target impression is excessively large, there would be a content that is suitable regardless of what target impression value the user designates. Accordingly, this may cause such a problem that the content cannot be selected in the poster generation process. Note that the case where the setting range is larger than the predetermined range is, in other words, the case where a difference between the upper limit value and the lower limit value of the setting range is equal to or more than a predetermined threshold.

Moreover, if there is no intersection range in the case where the intersection range of the setting ranges of multiple contents is determined as the setting range of the target impression as in the example illustrated in FIG. 17F described above, no setting range is outputted in S1603. In this case, the UI changing component 304 may display a not-illustrated warning screen, and notify the user that a suitable range of the target impression common to the designated multiple contents is absent. Moreover, it is preferable to prompt the user to designate other contents in the content setting screen 701, in this warning screen.

The process of changing the setting ranges of the target impression has been described above. Description returns to explanation of FIG. 15A.

The above-mentioned processes of S1501 to S1503 determine the setting ranges of the target impression suiting the content designated by the user, and causes the generation condition setting screen 801 in which the operable ranges of the UI (operation object) are changed to be displayed.

In S1504, the poster creation condition designation component 201 and the target impression designation component 204 obtain the settings corresponding to these components from the generation condition setting screen 801. Specifically, the poster creation condition designation component 201 obtains the size, the creation number, and the use application category of the poster designated by the user. The target impression designation component 204 obtains the target impression designated by the user.

In S1505, selection numbers are determined such that posters corresponding to the creation number designated in the poster creation condition designation component 201 can be generated. Specifically, the skeleton selection component 214 determines the number of skeletons to be selected, the color scheme pattern selection component 215 determines the number of color scheme patterns to be selected, and the font selection component 216 determines the number of fonts to be selected. In the present embodiment, the layout component 217 is assumed to generate pieces of poster data as many as the number of skeletons×the number of color scheme patterns×the number of fonts. The skeleton selection component 214, the color scheme pattern selection component 215, and the font selection component 216 determine the number of skeletons to be selected, the number of color scheme patterns to be selected, and the number of fonts to be selected such that the number of posters to be generated is equal to or more than the creation number designated in the poster creation condition designation component 201. For example, the number of skeletons, the number of color scheme patterns, and the number of fonts may each be determined according to Formula 1 described below.

$$selection number = ⌈ \sqrt[3]{creation number \times 2} ⌉ \qquad ( 1 )$$

where ┌x┐ is the number of ceiling functions, and is the smallest integer that is not smaller than x.

For example, in the case where the creation number is six, the selection number is three, the number of pieces of poster data to be generated by the layout component 217 is 27, and the poster selection component 219 selects six out of the 27 pieces of poster data. The poster selection component 219 can thereby select posters whose impressions of the entire posters further match the target impression, from among the pieces of poster data generated as many as or more than the creation number. Note that the method of determining the selection number is not limited to this, and the selection number may be determined by another method. Moreover, the selection number may be a fixed value.

In S1506, the image analysis component 212 executes the analysis process on the image data obtained in S1502, and obtains information indicating the feature amounts relating to each image. The information indicating the feature amounts includes, for example, meta information stored in the image and the information indicating the image feature values that can be obtained by analyzing the image. These pieces of information are used in the object recognition process that is the analysis process. Note that, although the object recognition process is executed as the analysis process in the present embodiment, the present disclosure is not limited to this, and other analysis processes may be executed. Moreover, the process of S1506 may be omitted. Details of the process performed in the image analysis component 212 in S1506 are explained below.

The image analysis component 212 executes the object recognition process on each image obtained in S1502. In this case, a publicly-known method can be used for the object recognition process. In the present embodiment, objects are recognized by a discriminator created by deep learning. The discriminator outputs a likelihood of whether a certain pixel forming the image is a pixel forming each object or not in a value of 0 to 1, and recognizes that the object is in the image for the object exceeding a certain threshold. The image analysis component 212 can obtain the types and positions of the objects such as face, flower, food, building, stationary object, landmark, and pets including dog, cat, and the like by recognizing an object image.

In S1507, the skeleton obtaining component 213 obtains the skeletons matching various setting conditions. In the present embodiment, the skeletons are assumed to be such that one skeleton is described in one file and saved in the HDD 104. The skeleton obtaining component 213 sequentially reads out the skeleton files from the HDD 104 to the RAM 103, and keeps the skeletons matching the setting conditions on the RAM 103 while deleting the skeletons not matching the conditions from the RAM 103. FIG. 15B is a flowchart of a condition determination process performed by the skeleton obtaining component 213 in S1507. The condition determination process executed by the skeleton obtaining component 213 is explained with reference to FIG. 15B.

In S1521, for each of the skeletons read into the RAM 103, the skeleton obtaining component 213 determines whether the poster size designated in the poster creation condition designation component 201 matches the size of the skeleton. Note that, although the size match is checked in this process, matching of the aspect ratio alone is sufficient. In this case, the skeleton obtaining component 213 enlarges or reduces the coordinate system of the read skeleton to obtain a skeleton matching the poster size designated in the poster creation condition designation component 201.

In S1522, the skeleton obtaining component 213 determines whether the use application category designated in the poster creation condition designation component 201 matches the category of the skeleton. The use application category of the skeleton to be used only for a specific use application is described in the skeleton file, and this skeleton is prevented from being obtained except for the case where this use application category selected. This can prevent the skeleton from being used in other use application categories in the case where the skeleton is designed specifically for a certain use application such as, for example, the case where a pattern invoking school is graphically drawn or the case where a pattern of sport goods is graphically drawn. Note that, in the case where no use application category is set in the generation condition setting screen 801, S1522 is skipped.

In S1523, the skeleton obtaining component 213 determines whether the number of image objects in the read skeleton matches the number of images obtained by the image obtaining component 211. In the case where the number of the image objects in the read skeleton matches the number of images obtained by the image obtaining component 211, the skeleton obtaining component 213 keeps this skeleton in the RAM 103. In the case where the numbers do not match, the skeleton obtaining component 213 deletes this skeleton from the RAM 103.

In S1524, the skeleton obtaining component 213 determines whether the text object of the read skeleton matches the character information designated in the text designation component 202. More specifically, the skeleton obtaining component 213 determines whether each type of character information designated in the text designation component 202 is present in the skeleton. For example, assume that character strings are designated in the title box 702 and the main text box 704 on the content setting screen 701, and blank is designated in the subtitle box 703. In this case, the skeleton obtaining component 213 search all text objects in the skeleton, and determines that the skeleton is suitable in the case where the text object for which “title” is set as the type of character information in the metadata and the text object for which “main text” is set as the type are both found, and determines that the skeleton is unsuitable in other cases. In the case where the text object of the read skeleton matches the character information designated in the text designation component 202, the skeleton obtaining component 213 keeps this skeleton in the RAM 103.

In the case where the text object does not match the character information, the skeleton obtaining component 213 deletes this skeleton from the RAM 103.

As described above, the skeleton obtaining component 213 keeps the skeletons in which the size, the use application category, the number of image objects, and the type of text object of the skeleton all match the conditions set in the generation condition setting screen 801, on the RAM 103. Note that, although the skeleton obtaining component 213 performs the determination for all skeleton files on the HDD 104 in the present embodiment, the present disclosure is not limited to this. For example, the poster creation application may hold a database in which file paths of the skeleton files are associated with the search conditions (skeleton size, the number of image objects, and type of text object) in advance, in the HDD 104. In this case, the skeleton obtaining component 213 can obtain the skeleton files at high speed by reading only the skeleton files determined to match the conditions as a result of searching on the database, from the HDD 104 to the RAM 103. Explanation returns to FIG. 15A.

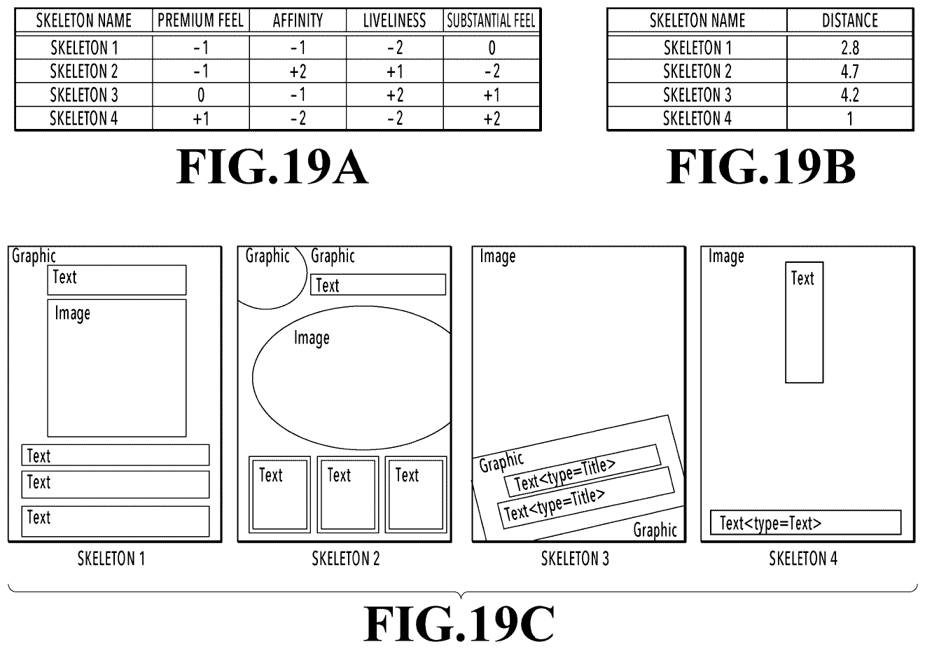

In S1508, the skeleton selection component 214 selects the skeletons matching the target impression designated in the target impression designation component 204 among the skeletons obtained in S1507. In this case, FIGS. 19A to 19C are diagrams for explaining a method by which the skeleton selection component 214 selects the skeletons. FIG. 19A is a diagram illustrating an example of a table in which the skeletons are associated with the impressions. In the column of skeleton name in FIG. 19A, a file name of each skeleton is described, and the columns of premium feel, affinity, liveliness, and substantial feel each illustrate a number (numerical value) indicating a level of an influence of the skeleton on a corresponding one of the impression factors. This numerical value is a value indicating that −2 is low, −1 is slightly low, 0 is neither high nor low, +1 is slightly high, and +2 is high for the impression. First, the skeleton selection component 214 determines a distance between the target impression obtained from the target impression designation component 204 and the impression of each of the skeletons illustrated in the skeleton impression table of FIG. 19A. For example, in the case where the target impression is “premium feel +1, affinity −1, liveliness −2, and substantial feel +2”, the distance determined by the skeleton selection component 214 is as illustrated in FIG. 19B. Note that, in the present embodiment, a Euclidean distance is used as the distance (hereinafter, mere distance means Euclidean distance). The smaller the value indicated by the Euclidean distance is, the closer the impression of the skeleton is to the target impression. Next, the skeleton selection component 214 selects top N skeletons in ascending order of the value indicated by the distance in FIG. 19B, N being the selection number. In the present embodiment, the skeleton selection component 214 is assumed to select top two skeletons. Specifically, the skeleton selection component 214 selects Skeleton 1 and Skeleton 4.

The value of N is determined depending on the conditions designated in the poster creation condition designation component 201. In the case where the value of N is a variable value, the selection number N may be determined by Formula 1 described above, or determined by another method. For example, in the case where the creation number is designated to be six in the creation number box 814 on the generation condition setting screen 801, the poster generation component 210 generates six posters. In the layout component 217 to be described later, the posters are generated by combining the skeletons, the color scheme patterns, and the fonts selected in the skeleton selection component 214, the color scheme pattern selection component 215, and the font selection component 216. Accordingly, for example, selecting two skeletons, two color scheme patterns, and two fonts enables generation of 2×2×2=8 posters, and this can satisfy the condition of the creation number of six.

Moreover, each of the ranges of the impression in the skeleton impression table in FIG. 19A does not have to be the same as the corresponding range of the impression designated in the target impression designation component 204. Although the range of the impression designated in the target impression designation component 204 is −2 to +2 in the present embodiment, the range of the impression in the skeleton impression table may be different from this range. In this case, the range in the skeleton impression table is scaled to match the range of the target impression, and then the above-mentioned distance calculation is executed. Furthermore, the distance determined by the skeleton selection component 214 is not limited to the Euclidean distance, and may be a Manhattan distance, a Cosine similarity, or the like as long as a distance between vectors can be determined. Moreover, the impression factors set to off with the radio buttons 812 are excluded from the distance determination calculation.

Note that, for example, the skeleton impression table is created in advance by estimating an impression of a poster image generated based on each skeleton with the color scheme pattern, the font, and the image and character data arranged on the skeleton fixed. Then, the skeleton impression table is saved in the HDD 104. Specifically, the impression of each of the poster images that are the same in the used images, the colors of used characters, and the like but vary in the arrangement of the characters, images, and the like is estimated, and characteristics relative to other skeletons are thereby formed into a table. In this case, it is desirable to perform a process of cancelling impressions given by the used color scheme pattern, image, and the like such as performing standardization across all estimated impressions, averaging impressions of multiple poster images generated from one skeleton by using multiple color scheme patterns and multiple images, or the like. Influences of the arrangement on the impression can be thereby formed into a table, the influences being, for example, such an influence that an impression of a skeleton with a small image is determined based on elements such as graphics and characters irrespective of the image and such an influence that liveliness is high in the case where images and characters are arranged in a tilted manner.

FIG. 19C illustrates examples of skeletons corresponding to Skeleton 1 to Skeleton 4 in FIG. 19A. For example, in Skeleton 1, an image object and text objects are regularly arranged, and the area of the image is small. Accordingly, liveliness is low. In Skeleton 2, a graphical object and an image object are circular. Accordingly, affinity is high, and substantial feel is low. In Skeleton 3, an image object is arranged in a large area, and a tilted graphical object is arranged to be laid over the image object. Accordingly, liveliness is high. In Skeleton 4, an image is arranged over the entire skeleton, and a text object is minimized. Accordingly, substantial feel is high, and liveliness is low. As described above, in the case where the poster image includes characters or an image, poster images varying in the impression are generated by the arrangement method of the characters or the image. Note that the method of creating the skeleton impression table is not limited to this, and the skeleton impression table may be estimated from characteristics of arrangement information itself such as areas and coordinates of images and title character strings, or may be manually adjusted. The skeleton impression table is saved in the HDD 104, and the skeleton selection component 214 reads out the skeleton impression table from the HDD 104 to the RAM 103, and refers to the skeleton impression table.

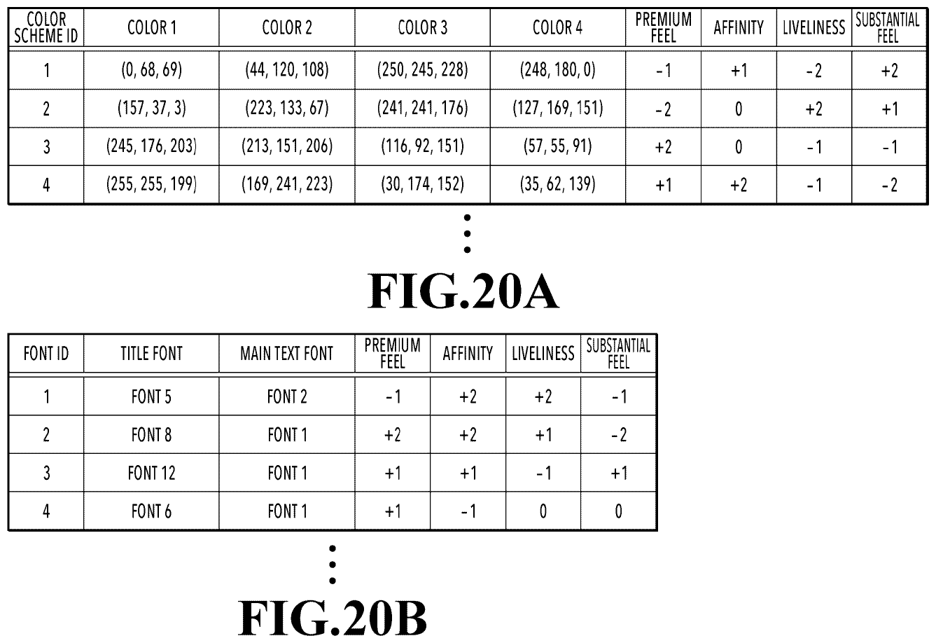

In S1509, the color scheme pattern selection component 215 selects the color scheme patterns matching the target impression designated in the target impression designation component 204. The color scheme pattern selection component 215 refers to an impression table corresponding to the color scheme patterns, and selects the color scheme patterns depending on the target impression, in a method similar to S1507. FIG. 20A illustrates an example of the color scheme pattern impression table in which the color scheme patterns are associated with the impressions. The color scheme pattern selection component 215 determines a value of a distance between the target impression and a value of a distance of an impression indicated by the columns of premium feel to substantial feel in FIG. 20A, and selects top N color scheme patterns in ascending order of the value of distance, N being the selection number. In the present embodiment, top two color scheme patterns are assumed to be selected. Note that, like the skeleton impression table, in the color scheme pattern impression table, tendencies of impressions of the color scheme patterns can be formed into a table by: creating posters varying in the color scheme pattern with the elements other than the color scheme pattern such as the skeleton, the font, and the image fixed; and estimating the impressions of the posters.

In S1510, the font selection component 216 selects combinations of fonts matching the target impression designated in the target impression designation component 204. The font selection component 216 refers to an impression table corresponding to the fonts, and selects the fonts depending on the target impression, in a method similar to S1507. FIG. 20B illustrates an example of the font impression table in which the fonts are associated with the impressions. The font selection component 216 determines a value of a distance between the target impression and a value of a distance of an impression indicated by the columns of premium feel to substantial feel in FIG. 20B, and selects top N fonts in ascending order of the value of distance, N being the selection number. Note that, like the skeleton impression table, in the font impression table, tendencies of impressions of the fonts can be formed into a table by: creating posters varying in the font with the elements other than the font such as the skeleton, the color scheme pattern, and the image fixed; and estimating the impressions of the posters.

In S1511, the layout component 217 sets the character information, the images, the color schemes, and the fonts for the skeletons selected in the skeleton selection component 214, and generates posters.

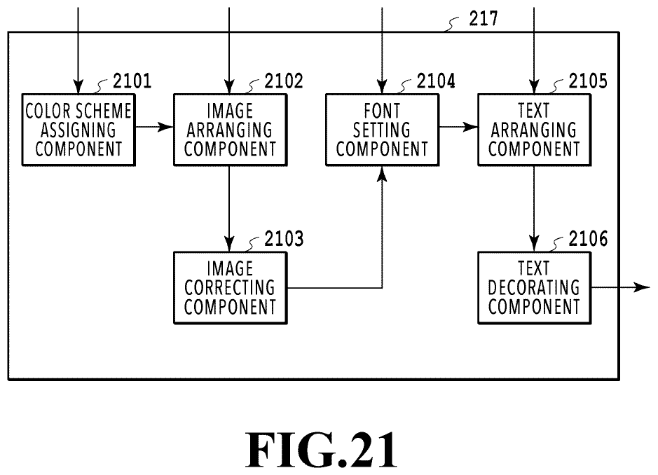

Next, the process of S1511 and a software configuration of the layout component 217 are explained in detail by using FIGS. 21, 22, 23A to 23C, and 24A to 24C.

FIG. 21 is an example of a software block diagram explaining the layout component 217 in detail. The layout component 217 includes a color scheme assigning component 2101, an image arranging component 2102, an image correcting component 2103, a font setting component 2104, a text arranging component 2105, and a text decorating component 2106.

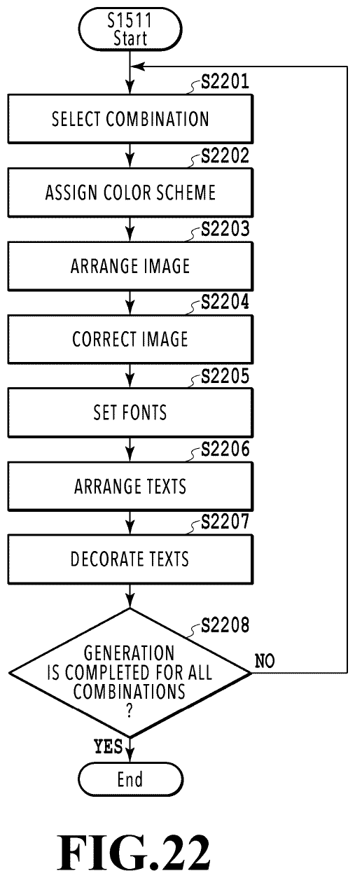

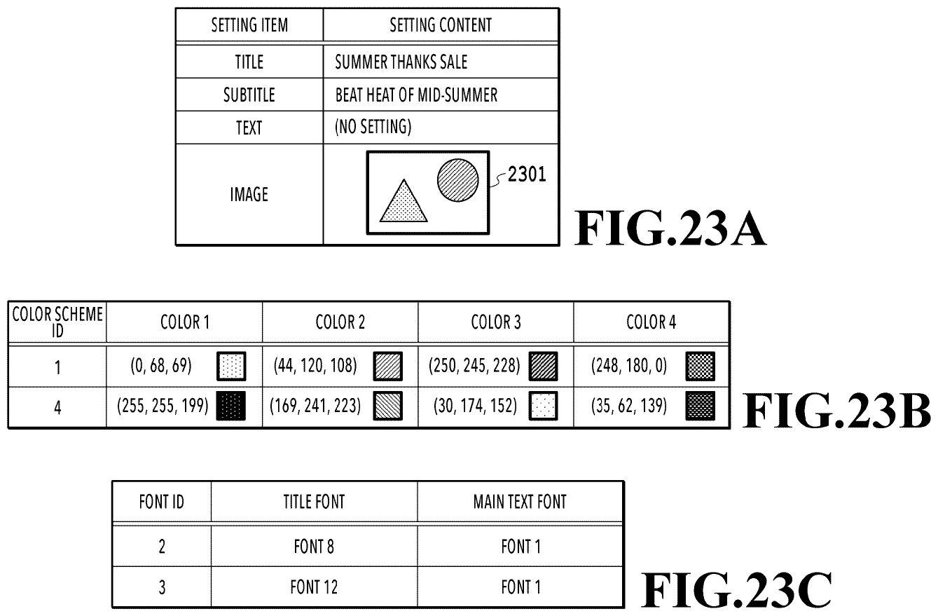

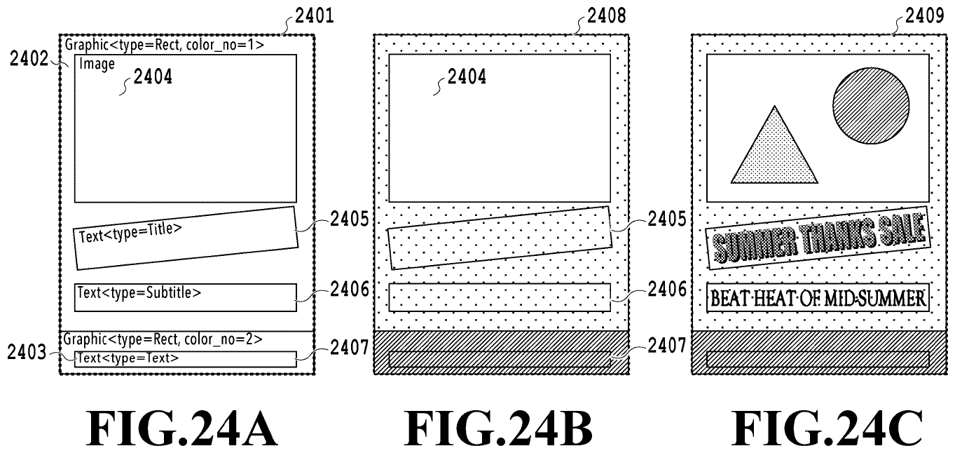

FIG. 22 is a flowchart for explaining the layout process of S1511 in detail. Moreover, FIGS. 23A to 23C are diagrams explaining information inputted into the layout component 217. FIG. 23A is a table summarizing the character information designated in the text designation component 202 and an image 2301 designated in the image designation component 203. FIG. 23B is an example of a table illustrating the color scheme patterns obtained from the color scheme pattern selection component 215, and FIG. 23C is an example of a table illustrating the fonts obtained from the font selection component 216. FIGS. 24A to 24C are diagram explaining a procedure of the process of the layout component 217.

First, the layout process of S1511 is explained in detail by using FIG. 22.

In S2201, the layout component 217 lists all combinations of the skeletons obtained from the skeleton selection component 214, the color scheme patterns obtained from the color scheme pattern selection component 215, and the fonts obtained from the font selection component 216. The layout component 217 sequentially generates pieces of poster data for the respective combinations by performing the layout process of S2202 and beyond. For example, in the case where: the number of skeletons obtained from the skeleton selection component 214 is three; the number of color scheme patterns obtained from the color scheme pattern selection component 215 is two; and the number of fonts obtained from the font selection component 216 is two, the layout component 217 generates 3×2×2=12 pieces of poster data. Next, in S2201, the layout component 217 selects one of the listed combinations, and executes the processes of S2202 to S2207.

In S2202, the color scheme assigning component 2101 assigns the color scheme pattern obtained from the color scheme pattern selection component 215, to the skeleton obtained from the skeleton selection component 214. FIG. 24A is a diagram illustrating an example of the skeleton. In the present embodiment, explanation is given of an example in which a color scheme pattern with a color scheme ID of 1 in FIG. 23B is assigned to a skeleton 2401 in FIG. 24A. The skeleton 2401 in FIG. 24A is formed of two graphical objects 2402 and 2403, one image object 2404, and three text objects 2405, 2406, and 2407. First, the color scheme assigning component 2101 assigns colors to each of the graphical objects 2402 and 2403. Specifically, the color scheme assigning component 2101 assigns a corresponding color from the color scheme pattern, based on a color scheme number that is metadata described in the graphical object. Next, the color scheme assigning component 2101 assigns, for example, the last color in the color scheme pattern to the text object (Text<type=Title ) whose metadata is type and whose attribute is “title” among the text objects. Specifically, in the present embodiment, Color 4 is assigned to the characters arranged in the text object 2405. Next, the color scheme assigning component 2101 sets a character color for characters arranged in each of the text objects 2406 and 2407 whose metadata is type and whose attributes are attributes other than “title” among the text objects, based on brightness of a background of the text object. In the present embodiment, the character color is set to white in the case where the brightness of the background of the text object is equal to or higher than a threshold, and is set to black if not. FIG. 24B is a diagram illustrating a state of a skeleton 2408 after execution of the color scheme assigning process described above. The color scheme assigning component 2101 outputs the skeleton data 2408 subjected to the color scheme assignment to the image arranging component 2102.

In S2203, the image arranging component 2102 arranges the image data obtained from the image analysis component 212 on the skeleton data 2408 obtained from the color scheme assigning component 2101, based on attached analysis information. In the present embodiment, the image arranging component 2102 assigns the image data 2301 to the image object 2404 in the skeleton. Moreover, in the case where the aspect ratio of the image object 2404 varies from that of the image data 2301, the image arranging component 2102 crops the image data 2301 such that the aspect ratio of the image data 2301 matches the aspect ratio of the image object 2404. More specifically, the image arranging component 2102 crops the image data 2301 based on a position of an object obtained by analyzing the image data 2301 with the image analysis component 212 such that an object region reduced by the cropping is minimized. Note that the cropping method is not limited to this, and other cropping methods such as, for example, cropping a center portion of the image or adjusting a composition such that a face position forms a triangular composition may be used. The image arranging component 2102 outputs the skeleton data subjected to the image assignment to the image correcting component 2103.

In S2204, the image correcting component 2103 obtains the skeleton data subjected to the image assignment from the image arranging component 2102, and corrects the image arranged in the skeleton. In the present embodiment, in the case where the resolution of the image is insufficient, an up-sampling process by a super-resolution process is performed.

First, the image correcting component 2103 determines whether the image arranged in the skeleton satisfies a certain resolution. For example, assume that an image of 1,600 px×1,200 px is assigned to a region of 200 mm×150 mm on the skeleton. In this case, the print resolution of the image can be calculated by using Formula 2.

$$\frac{1600}{200 \div 25.4} \approx 203 [ dpi ] \qquad ( 2 )$$

Next, in the case where the image correcting component 2103 determines that the print resolution of the image is lower than a threshold, the image correcting component 2103 improves the resolution by performing the super-resolution process. Meanwhile, in the case where the image correcting component 2103 determines that the print resolution of the image is equal to or higher than the threshold and the image has a sufficient resolution, no particular image correction is performed. In the present embodiment, the super-resolution process is performed in the case where the print resolution of the image is lower than 300 dpi.

In S2205, the font setting component 2104 sets the fonts obtained from the font selection component 216 for the skeleton obtained from the image correcting component 2103 and subjected to the image correction. FIG. 23C is an example of the combination of fonts selected by the font selection component 216. In the present embodiment, explanation is given of an example of assigning fonts in the case where the fonts assigned to the skeleton data subjected to the image correction are fonts of font ID “2” in FIG. 23C. In the present embodiment, the fonts are set for the text objects 2405, 2406, and 2407 in the skeleton 2408. Note that, in the poster, a font that stands out is set for the title from the viewpoint of noticeability, and a font that is easily readable is set for characters other than the title from the viewpoint of viewability in many cases. Accordingly, in the present embodiment, the font selection component 216 selects two types of fonts that are a title font and a main text font. The font setting component 2104 sets the title font for the text object 2405 whose attribute is “title”, and sets the main text font for the other text objects 2406 and 2407. The font setting component 2104 outputs the skeleton data subjected to the font setting to the text arranging component 2105. Note that, although the font selection component 216 selects two types of fonts in the present embodiment, the present disclosure is not limited to this, and for example, only the title font may be selected. In this case, the font setting component 2104 uses a font corresponding to the title font as the main text font. Specifically, the main text font matching the type of the title font may be set as follows: for example, in the case where a font of a Gothic family is used for the title, a typical Gothic font with high readability is used for the other text objects, and in the case where a font of a Ming family is used for the title, a typical Ming font is used for the other text objects. As a matter of course, the title font and the main text font may be identical. Moreover, different fonts may be used as follows depending on a degree at which the text objects are desired to be made noticeable: for example, the title font is used for the text objects of the title and the subtitle while the main text font is used for the other text objects; or the title font is used for characters of a certain font size or larger.

In S2206, the text arranging component 2105 arranges the texts designated in the text designation component 202 on the skeleton data obtained from the font setting component 2104 and subjected to the font setting. In the present embodiment, texts illustrated in FIG. 23 A are assigned with reference to the attributes of metadata of the text objects in the skeleton. Specifically, “Summer Thanks Sale” whose attribute is title is assigned to the text object 2405, and “Beat Heat of Mid-Summer” whose attribute is subtitle is assigned to the text object 2406. Since no main text is set, nothing is assigned to the text object 2407. FIG. 24C illustrates a skeleton 2409 that is an example of skeleton data after the process by the text arranging component 2105. The text arranging component 2105 outputs the skeleton data 2409 subjected to the text arrangement to the text decorating component 2106.

In S2207, the text decorating component 2106 decorates the text objects in the skeleton obtained from the text arranging component 2105 and subjected to the text arrangement. In the present embodiment, in the case where a color difference between the title character and a background region of the title character is equal to or less than a threshold, a process of adding an outline to the title character is performed. This improves the readability of the title. The text decorating component 2106 outputs the decorated skeleton data, that is the poster data for which the layout is completely finished, to the poster impression estimation component 218.

In S2208, the layout component 217 determines whether the poster data is generated in all combinations. In the case where the layout component 217 determines that the poster data is generated in all combinations of the skeletons, the color scheme patterns, and the fonts, the layout component 217 terminates the layout process, and transitions to S1512. In the case where the layout component 217 determines that the poster data is not generated in all combinations, the process returns to S2201, and the poster data is generated in a combination in which the poster data is not generated yet.

The layout process of S1511 has been described above. Description returns to the explanation of FIG. 15A.

In S1512, the poster impression estimation component 218 associates an estimated impression, obtained by executing a rendering process on each piece of poster data obtained from the layout component 217 and estimating the impression of the rendered poster image, with the poster data. Note that the rendering process is a process of converting the poster data to the image data. For example, even in posters of the same color scheme pattern, the arrangement varies in the case where the skeleton varies. Accordingly, an area in which each color is actually used varies. Thus, it is necessary to evaluate not only the tendency of the impression of each of the color scheme patterns and the skeletons but also the impression of the final poster. Accordingly, the present process is executed at this timing. This allows evaluation of not only the impression of each of the elements in the poster such as the color scheme and the arrangement but also the impression of the final poster in which the image and the characters are included and laid out.

In S1513, the poster selection component 219 selects the poster to be outputted to the display 105 (to be presented to the user) based on the pieces of poster data obtained from the poster impression estimation component 218 and the estimated impressions associated with the pieces of poster data. In the present embodiment, the poster selection component 219 selects a poster in which a value of a distance between the target impression and the estimated impression of the poster is equal to or less than a predetermined threshold.

Note that a Euclidean distance is used as the distance in the present embodiment. The smaller the value indicated by the Euclidean distance is, the closer the estimate impression is to the target impression. Moreover, the distance determined by the poster selection component 219 is not limited to the Euclidean distance, and may be a Manhattan distance, a Cosine similarity, or the like as long as a distance between vectors can be determined.

Moreover, in the case where the number of selected posters is less than the creation number designated in the poster creation condition designation component 201, the poster selection component 219 selects posters for filling an insufficient amount, in ascending order of the value of the distance between the target impression and the estimated impression of each poster. Note that, although the poster selection component 219 selects the posters filling the insufficient amount in the present embodiment, the present disclosure is not limited to this. For example, in the case where the number of posters selected by the poster selection component 219 is less than the creation number, information indicating that the number of posters is insufficient may be displayed on the poster preview screen 901 (FIG. 9). Alternatively, the poster selection component 219 may select the posters filling the insufficient amount, and then display the posters on poster preview screen 901 such that the posters for which the value of the distance between the target impression and the estimated impression is equal to or smaller than the threshold are distinguishable from the posters for which the value is larger than the threshold. Moreover, for example, the configuration may be such that, in the case where the number of selected posters is insufficient, the process returns to S1505, and the selection numbers of the skeletons, color scheme patterns, and fonts are increased.

In S1514, the poster display component 205 renders each piece of poster data selected by the poster selection component 219, and outputs the poster image to the display 105. Specifically, the poster image is displayed on the poster preview screen 901 of FIG. 9.

The poster generation process (S1404) in the content prioritized mode has been explained above. As explained above, in the poster generation process in the content prioritized mode, the poster creation application determines the ranges of the target impression designatable by the user, based on the estimated impression of the content designated by the user, and presents the ranges to the user. Specifically, the control is performed such that the ranges of the target impression designatable by the user in the case where the designation of the first content is received are different from the ranges of the target impression designatable by the user in the case where the designation of the second content different from the first content is received. Moreover, the poster creation application generates the posters based on the target impression designated by the user, within the ranges of the target impression.

Accordingly, in the case where the content prioritized mode is set, the ranges of the designatable target impression are limited to the ranges suiting the content designated by the user. Thus, the designation of the target impression is facilitated for the user, and the usability in the designation of the target impression is improved. More specifically, in a conventional technique, in the case where a target impression that does not match the content to be used in the poster is set, the poster generated by the poster creation application is outputted as a result not matching the content. Accordingly, the user has to repeat the designation of the target impression multiple times to obtain a poster with a desired design. However, in the present embodiment, the target impression can be designated based on the ranges better suiting the content than the normal setting range (reference range) of the target impression, more specifically, the setting ranges limited to the ranges close to the impression of the content. This facilitates the designation of the target impression suiting the inputted content also for a user with poor design skill. The user can more quickly reach a poster with a design suiting the designated content in fewer trials before the obtaining of the poster.

### Poster Generation Process in Impression Prioritized Mode

Next, the poster generation process in the impression prioritized mode is explained.

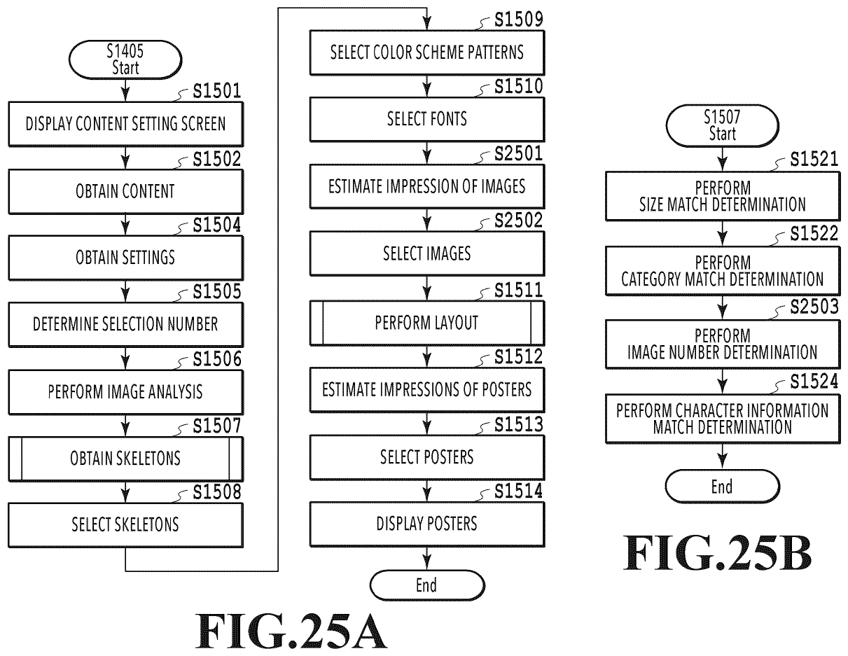

FIGS. 25A and 25B are flowcharts for explaining the poster generation process in the impression prioritized mode in detail. The present flowchart is executed in S1405 to which the process transitions in the case where the impression prioritized mode is set in the mode switching process illustrated in FIG. 14. Note that, since processes similar to those in FIGS. 15A and 15B (poster generation process in the content prioritized mode) are executed in steps of FIG. 25A and 25B that are denoted by the same reference numerals as those in FIGS. 15A and 15B, explanation thereof is omitted. In the poster generation process in the impression prioritized mode, S1503 (changing of the setting ranges of the target impression) in the poster generation process in the content prioritized mode is omitted. Moreover, image impression estimation (S2501) and image selection (S2502) are added between S1510 (font selection) and S1511 (layout process).

Moreover, processing contents of the condition determination process performed by the skeleton obtaining component 213 in S1507 are different from those in the content prioritized mode. Specifically, as illustrated in the flowchart of FIG. 25B, image number determination of S2503 is executed instead of S1523 (image number match determination). Moreover, in the impression prioritized mode, the target impression setting control component 220 illustrated in FIG. 2 is not used. Portions different from those in the content prioritized mode are explained below.

In S2503 (condition determination process performed by the skeleton obtaining component 213) of FIG. 25B, the skeleton obtaining component 213 determines whether the number of image objects in the read skeleton is one. In the case where the number of image objects is one, the skeleton obtaining component 213 keeps this skeleton on the RAM 103. In the case where the number of image object is not one, the skeleton obtaining component 213 deletes this skeleton from the RAM 103.

In S2501 of the poster generation process in the impression prioritized mode illustrated in FIG. 25A, the image impression estimation component 221 estimates the impression of each of the one or multiple pieces of image data obtained in S1506, and associates the estimated impression values with a corresponding piece of image data.

In S2502, the image selection component 222 selects one of the one or multiple pieces of image data obtained in S2501, based on the estimated impression associated with each piece of the image data and the target impression set in S1504. In the present embodiment, the image selection component 222 selects one piece of image data for which the distance between the estimated impression and the target impression is the smallest. The layout process of S1511 is executed in a state where one piece of image data is selected as described above.

As explained above, in the poster generation process in the impression prioritized mode, one content (image in the example described above) suiting the target impression set by the user is selected from among the contents designated by the user, and is used in the generation of the poster.

### Modified Example of First Embodiment

Although the setting of the target impression is performed by using the impression sliders 808 to 811 of the content setting screen 701 as the objects operated to set the target impression in the first embodiment, the setting method of the target impression is not limited to this.

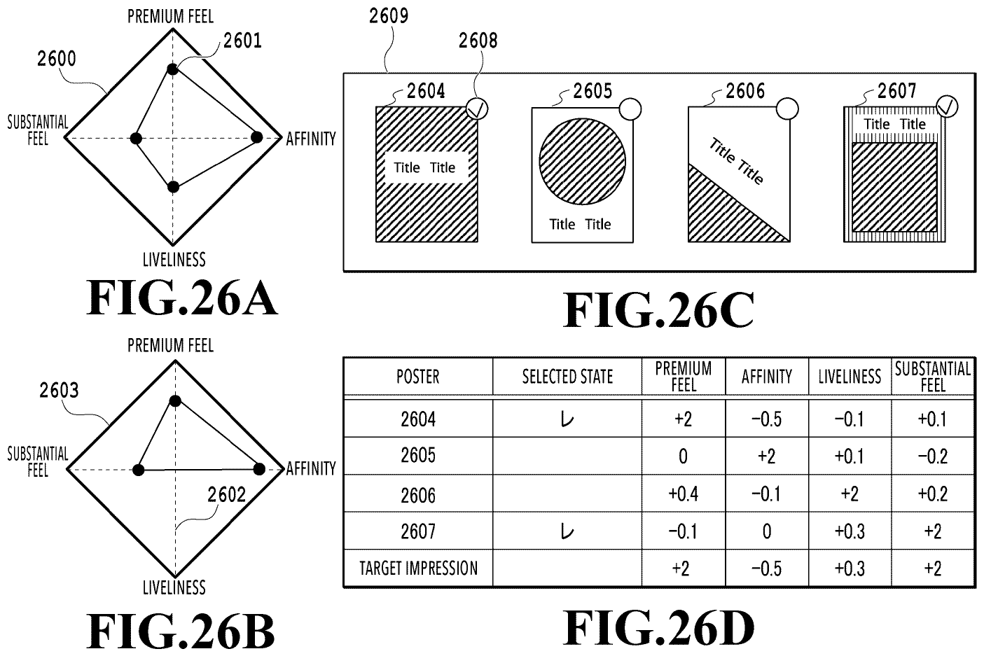

FIGS. 26A to 26D are diagrams illustrating examples of the UI for the setting of the target impression. FIG. 26A illustrates an example of setting the target impression by using a UI on a radar chart 2600. The target impression values of the respective impression factors set on the respective axes of the radar chart 2600 in FIG. 26A can be set by operating handles 2601 on the radar chart 2600. For example, the target impression designation component 204 obtains the target impression value for each axis such that the target impression value is −2 in the case where the handle 2601 is at the center in the UI, and is +2 in the case where the handle 2601 is at the outer-most position in the UI. In FIG. 26A, the target impression values are premium feel +0.8, affinity +1.1, liveliness −0.1, and substantial feel −0.7. As described above, the target impression value may include decimals. Moreover, a radar chart 2603 of FIG. 26B illustrates a state where one of the impression factors is set to off. For example, the user can double click the handle with the pointing device 107 to set the target impression value of the axis corresponding to this handle to off and hide the target impression value. Note that the user can click an axis 2602 on the radar chart 2603 with the pointing device 107 again to set this target impression value to on and display this target impression value again. FIG. 26B is a state in which the target impression values of the impression factors other than liveliness are the same as those in FIG. 26A and liveliness is set to off.

Note that, in the content prioritized mode, the UI changing component 304 changes the operable ranges depending on the setting ranges determined by the setting range determination component 303 also in the case where the target impression is set by using the UI on the radar chart, as in the UI on the sliders explained in the first embodiment. Specifically, the UI changing component 304 changes the setting range indicated by each axis such that the lower limit value of the setting range after the change determined by the setting range determination component 303 can be obtained in the case where the handle 2601 is at the center of the radar chart 2600 in the UI, and the upper limit value of the setting range after the change can be obtained in the case where the handle 2601 is at the outer-most position. Alternatively, the configuration may be such that the setting range indicated by each axis in the radar chart 2600 in the UI is the same as the normal setting range, and the range in which the handle 2601 can be operated is limited to the setting range after the change determined by the setting range determination component 303. In this case, an initial position of the handle 2601 may be set to a position indicating the estimated impression value of the content. Moreover, a range in which the operation cannot be performed may be illustrated in a display form different from the operable range, for example, illustrated in gray.

FIG. 26C illustrates an example of a UI in which the target impression is set based on samples of poster images (hereinafter, referred to as sample poster images) instead words such as “premium feel” and “affinity”. Sample poster images 2604 to 2607 in each of which one of impressions is great are arranged in a sample poster display region 2609. Moreover, a check box 2608 is displayed in each of the sample poster images. The user can click the sample poster image assumed to be close to the impression of the poster desired to be created with the pointing device 107 to turn on the check box 2608 and set the check box 2608 to a selected state. The target impression designation component 204 determines the target impression by referring to impression values corresponding to the sample poster image in the selected state.

FIG. 26D is a table illustrating the impression values corresponding to the sample poster images 2604 to 2607 in FIG. 26C and final target impression values. The columns of premium feel, affinity, liveliness, and substantial feel each illustrate a number indicating a level of an influence of each sample poster image on the corresponding impression factor. For example, assume that the sample poster images 2604 and 2607 are in the selected state as in FIG. 26C. In this case, the target impression designation component 204 determines impression values obtained by combining the impression values of the sample poster images 2604 and 2607, as the final target impression values. In this example, for each impression factor, the value with the larger absolute value out of the values corresponding to the selected sample poster images 2604 and 2607 is set as the final target impression value. Note that, although description is given of the example in which the poster images in each of which one of the impressions is the greatest are presented, the present disclosure is not limited to this. A sample poster image in which impression values of multiple impression factors are large may be used, or sample poster images more than the number of impression factors may be presented. The user can thereby intuitively designate the target impression based on actual poster images without using words.

Note that, in the content prioritized mode, the UI changing component 304 changes the operable ranges depending on the setting ranges determined by the setting range determination component 303 also in the UI (FIG. 26C) in which the target impression is set based on the sample poster images. Specifically, the UI changing component 304 limits the sample poster images to be displayed in the sample poster display region 2609 to sample poster images having impression values within the setting ranges determined by the setting range determination component 303. Alternatively, a predetermined number of sample poster images having impression values close to the setting ranges determined by the setting range determination component 303 may be selected and displayed in ascending order of distances between the setting ranges and the impression values of the sample image. In this case, a state in which a sample poster image having impression values whose distances to the estimated impression values of the content designated by the user are the smallest is selected may be displayed as an initial state of the sample poster display region 2609.

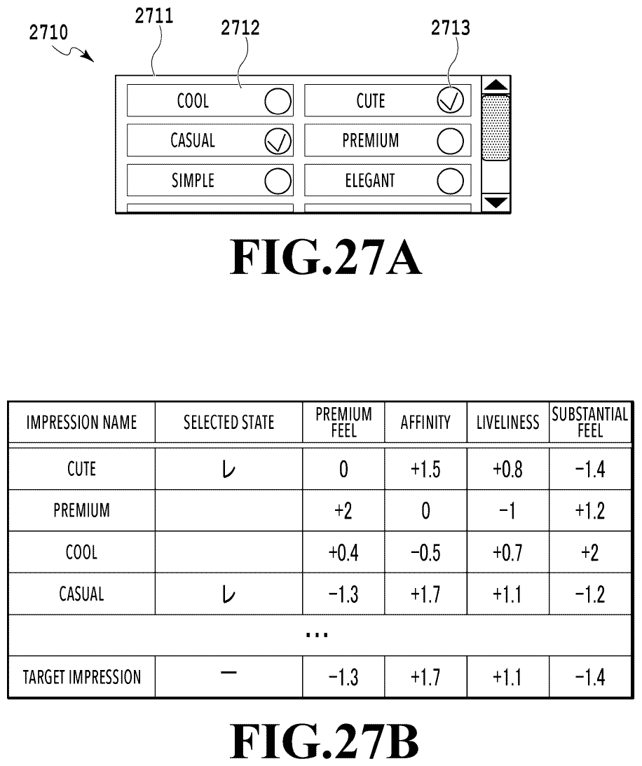

FIG. 27A illustrates an example of a UI in which the target impression is set based on abstract words (hereinafter, referred to as “impression words”) representing impressions. Multiple impression words 2712 are arranged and displayed in an impression word display region 2711. Moreover, a check box 2713 is displayed for each of the multiple impression words 2712. The user can click the impression word assumed to be close to the impression of the poster desired to be created with the pointing device 107 to turn on the check box 2713 and set the check box 2713 to the selected state. The target impression designation component 204 determines the target impression by referring to the impressions corresponding to the impression words in the selected state.

FIG. 27B is a table illustrating values of the impression factors corresponding to each of the multiple impression words 2712 displayed in FIG. 27A and the final target impression. The columns of premium feel, affinity, liveliness, and substantial feel (columns of impression factors) each illustrate a number indicating a level of an influence of each impression word 2712 on the corresponding impression factor. For example, assume that “cute” and “casual” are in the selected state as in FIG. 27A. In this case, for each impression factor, the target impression designation component 204 determines a value obtained by combining the respective values of the impression words, as the final target impression. In this example, for each impression factor, the value with the larger absolute value out of the values corresponding to the selected impression words of “cute” and “casual” is set as the final target impression value of the impression factor. The user can thereby intuitively designate the target impression based on the impression words without setting the target impression as the values of the multiple impression factors. Note that the values of the respective impression factors corresponding to each impression word are determined in advance in a method similar to the impression quantification process of the text explained in FIG. 12B. Specifically, the information processing apparatus can derive the values of the respective impression factors corresponding to each impression word by performing the processes of S1211 to S1214. Moreover, the values of the respective impression factors corresponding to each impression word can be derived (estimated) by applying the impression estimation model saved in S1214 to the impression word.

Note that, in the content prioritized mode, the UI changing component 304 changes the UI depending on the setting ranges determined by the setting range determination component 303 also in the UI (FIG. 27A) in which the target impression is set based on the impression words, as in the UI on the sliders explained in the first embodiment. Specifically, the UI changing component 304 limits the impression words 2712 displayed in the impression word display region 2711 to impression words having impression values within the setting ranges determined by the setting range determination component 303. Alternatively, impression words having impression values outside the setting ranges determined by the setting range determination component 303 may be set to an unselectable state. In this case, a state in which the impression word having impression values whose distances to the estimated impression values of the content designated by the user are the smallest is selected may be displayed as an initial state of the UI 2710.

### Second Embodiment

In a second embodiment, explanation is given of an example in which the poster creation application presents a template instead of poster generation. A template is data in which the skeleton, the color scheme pattern, the font, the image, and the character information are combined. In the second embodiment, multiple templates are assumed to be prepared in advance, and stored in the HDD 104 of the poster generation apparatus 100.

In the content prioritized mode, the poster creation application of the second embodiment displays the UI (operation object) in which the setting ranges of the target impression designatable by user are changed based on the impression of the content designated by the user, as in the first embodiment. Then, the poster creation application of the second embodiment selects a template close to the impression of the content from among the templates prepared in advance, based on the target impression designated by the user by using the operation object in which the setting ranges of the target impression are changed, and proposes the selected template to the user. This allows the template suiting the content designated by the user to be presented, and can reduce the work and time of the user finding the template and facilitate creation of the poster with an intended design, also in the case where the user generates a poster by editing a template.

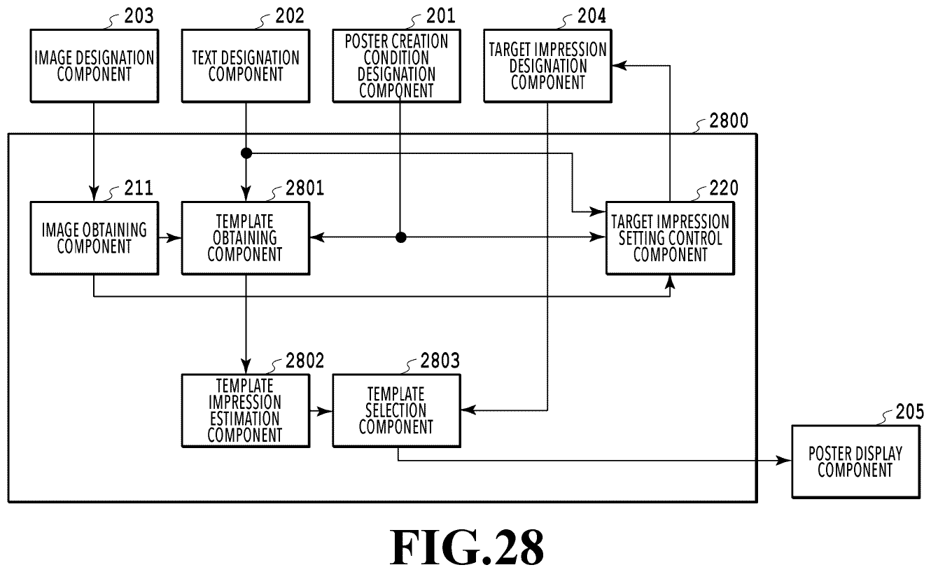

FIG. 28 is a software block diagram in the case where the content prioritized mode is set in the poster creation application of the second embodiment. As illustrated in FIG. 28, the poster creation application includes the poster creation condition designation component 201, the text designation component 202, the image designation component 203, the target impression designation component 204, the poster display component 205, and a poster generation component 2800 of the second embodiment. The poster generation component 2800 of the second embodiment includes the target impression setting control component 220, the image obtaining component 211, a template obtaining component 2801, a template impression estimation component 2802, and a template selection component 2803.

A point different from the poster generation component 210 of the first embodiment is that the template obtaining component 2801 is provided. Moreover, the skeleton obtaining component 213, the skeleton selection component 214, the color scheme pattern selection component 215, the font selection component 216, the image analysis component 212, the image impression estimation component 221, the image selection component 222, and the layout component 217 in FIG. 2 are omitted. Furthermore, the template impression estimation component 2802 is provided instead of the poster impression estimation component 218, and the template selection component 2803 is provided instead of the poster selection component 219. In FIG. 28, configurations denoted by the same reference numerals as those in FIG. 2 are the same as those in the first embodiment, and explanation thereof is thus omitted.

The template obtaining component 2801 obtains a template group matching the conditions designated in the poster creation condition designation component 201, the text designation component 202, and the image obtaining component 211, from the HDD 104. The template obtaining component 2801 outputs the obtained template group to the template impression estimation component 2802.

The template impression estimation component 2802 estimates estimated impressions of each of templates included in the template group obtained by the template obtaining component 2801. Then, the multiple templates associated with the respective estimated impressions are outputted to the template selection component 2803.

The template selection component 2803 compares the target impression designated by the user in the target impression designation component 204 and the estimated impression of each of the multiple templates associated with the estimated impressions that is obtained from the template impression estimation component 2802. Then, the template selection component 2803 selects one or multiple templates associated with the estimated impressions close to the target impression. The template selection component 2803 outputs the selected templates to the poster display component 205.

The poster display component 205 displays the templates obtained from the template selection component 2803 on the display 105.

### Template Selection Process

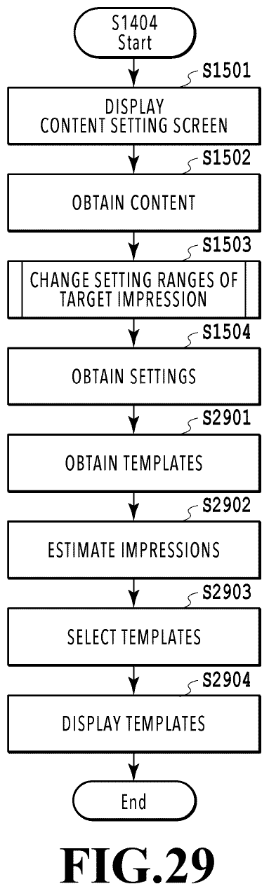

FIG. 29 is a flowchart illustrating a template selection process in the content prioritized mode in the second embodiment. The process illustrated in the present flowchart is executed in S1404 to which the process transitions in the case where the content prioritized mode is selected in the mode switching process (FIG. 14). Note that, since processes denoted by the same reference numerals as those in FIGS. 15A and 15B (poster generation process in the content prioritized mode of the first embodiment) are the same as the processes in the first embodiment, explanation thereof is omitted. In the template selection process (FIG. 29) in the content prioritized mode of the second embodiment, S2901 to S2904 are executed instead of S1505 to S1514 illustrated in FIGS. 15A and 15B.

In S1501 to S1503, the poster creation application displays the content setting screen 701 illustrated in FIG. 7 on the display 105 as in the first embodiment. The text designation component 202 and the image designation component 203 receive the designation of text and the designation of image by the user, and obtain the image data and the character information. The target impression setting control component 220 executes the process of changing the setting ranges of the target impression designatable by the user, based on the obtained contents (image data and character information). The process of changing the setting ranges of the target impression is the same as that in the first embodiment. The target impression setting control component 220 determines the setting ranges of the target impression depending on the contents (image and character information), and displays the generation condition setting screen 801 including the UI in which the setting ranges are changed to the determined setting ranges, on the display 105.

In S1504, the poster creation condition designation component 201 and the target impression designation component 204 obtain the settings corresponding to the these components from the generation condition setting screen 801 of FIG. 8. Specifically, the poster creation condition designation component 201 obtains the size, the creation number, and the use application category of the poster designated by the user. The target impression designation component 204 obtains the target impression designated by the user.

Then, in S2901, the template obtaining component 2801 obtains one or multiple templates matching the conditions designated in the poster creation condition designation component 201, the text designation component 202, and the image obtaining component 211, from the HDD 104. In the second embodiment, the templates are assumed to be such that one template is described in one file and saved in the HDD 104.

The template obtaining component 2801 sequentially reads out the template files from the HDD 104 to the RAM 103, and keeps the templates matching the setting conditions in the RAM 103 while deleting the templates not matching the conditions from the RAM 103. Then, the template obtaining component 2801 outputs the one or multiple templates matching the setting conditions to the template impression estimation component 2802.

In S2902, the template impression estimation component 2802 estimates the impression of each of the one or multiple templates obtained in S2901. In the present embodiment, for example, it is assumed that the impression values are estimated in advance for each of the templates saved in the HDD 104, and a table in which each template is associated with the estimated impression is created and saved in the HDD 104. The template impression estimation component 2802 obtains the table saved in the HDD 104 to obtain the estimated impression of each of the obtained templates. Note that, in the impression estimation of the template, the impression estimation model used in the impression estimation of the poster may be used.

In S2903, the template selection component 2803 selects the template to be outputted to the display 105 (to be presented to the user) based on the templates obtained from the template impression estimation component 2802 and the estimated impressions associated with the templates. In the present embodiment, the template selection component 2803 selects a template in which a value of a distance between the target impression designated by the user and the estimated impression of the template is equal to or less than a predetermined threshold. For example, the number of templates to be selected is assumed to be equal to or more than the creation number designated by the user in the generation condition setting screen 801. In this case, the template selection component 2803 selects templates as many as or more than the creation number, in ascending order of a value indicating a difference between the target impression and the estimated impression. Closeness of the target impression and the estimated impression is determined based on an impression value difference of each impression factor.

In S2904, the poster display component 205 displays the templates selected in S2903 on the display.

As explained above, according to the second embodiment, the templates in which various color schemes, fonts, images, and character information are set can be prepared in advance. Then, in the case where the operation mode is set to the content prioritized mode, the poster creation application displays the UI (operation object) in which the setting ranges of the target impression designatable by the user are changed based on the impression of the content designated by the user. Then, the poster creation application selects the templates close to the impression of the content from among the templates prepared in advance, based on the target impression designated by the user by using the operation object, and propose the selected templates to the user. The UI (operation object) suiting the content designated by the user facilitates designation of the target impression suiting the content also in the case where the user generates a poster by editing a template. The number of times of trial until the template close to the target impression designated by the user is presented can be reduced, and it is possible to reduce work of the user finding the template and facilitate creation of an intended design.

### Third Embodiment

In the poster creation application of the first embodiment and the second embodiment, explanation is given of an example in which the target impression setting control component 220 changes the setting ranges of the target impression designatable by the user, depending on the impression of the content designated by the user. In a third embodiment, the target impression setting control component 220 changes the setting ranges of the target impression designatable by the user, based on a use application category designated by the user in addition to the impression of the content designated by the user. The target impression setting control component 220 can thereby determine setting ranges of the target impression that reflect the intention of the user more precisely.

Since a basic process of the poster generation process of the third embodiment is the same as that in the example explained in the first embodiment, different points are mainly explained below.

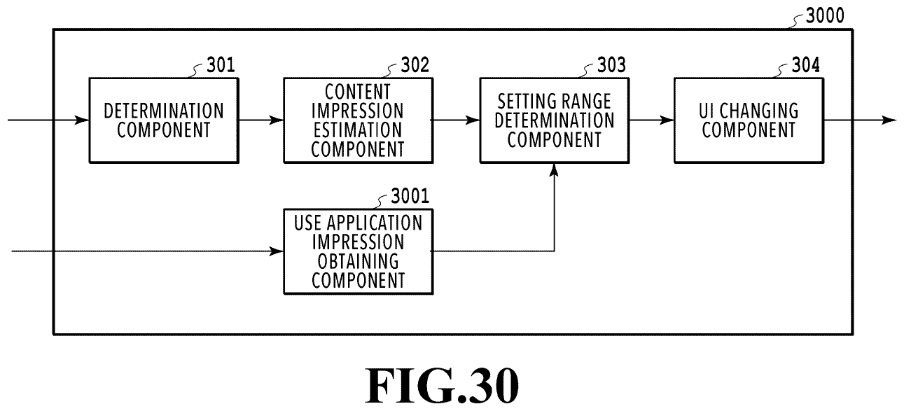

FIG. 30 is a software block diagram explaining a target impression setting control component 3000 in the content prioritized mode of the third embodiment in detail. As illustrated in FIG. 30, the target impression setting control component 3000 in the content prioritized mode of the third embodiment includes the determination component 301, the content impression estimation component 302, the setting range determination component 303, the UI changing component 304, and a use application impression obtaining component 3001. The target impression setting control component 3000 is different from the target impression setting control component 220 of the first embodiment in that the use application impression obtaining component 3001 is added. Since configurations in FIG. 30 denoted by the same reference numerals as those in FIG. 3 are the same as those in the first embodiment, explanation thereof is omitted in this section.

The use application impression obtaining component 3001 obtains the use application category of the poster to be created, from the poster creation condition designation component 201. The use application category of the poster to be created is selected by the user from the category list box 815 of the generation condition setting screen 801 illustrated in FIG. 8. The use application impression obtaining component 3001 obtains impression ranges suiting the obtained use application category, from the HDD 104, and outputs the ranges to the setting range determination component 303. Note that the poster creation application holds a database in which each use application category is associated in advance with the impression ranges suiting the use application category, in the HDD 104.

The setting range determination component 303 determines the setting ranges of the target impression based on the estimated impression of the content obtained from the content impression estimation component 302 and the impression ranges of the use application category obtained from the use application impression obtaining component 3001, and outputs the setting ranges of the target impression to the UI changing component 304.

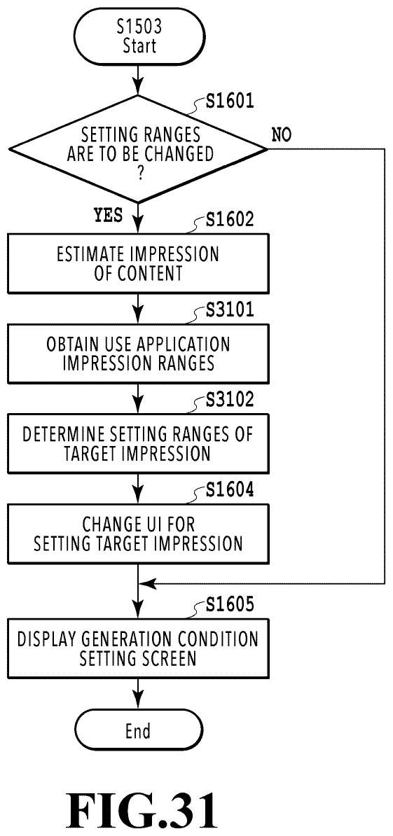

FIG. 31 is a flowchart illustrating a process of changing the setting ranges of the target impression in the third embodiment. FIG. 31 is a process executed in S1503 of the poster generation process (FIGS. 15A and 15B) in the content prioritized mode. This process is executed by the determination component 301, the content impression estimation component 302, the use application impression obtaining component 3001, the setting range determination component 303, and the UI changing component 304 illustrated in the target impression setting control component 3000. Note that, since processes in FIG. 31 denoted by the same reference numerals as those in FIG. 16 (process of changing the setting ranges of the target impression in the first embodiment) are the same as the processes explained in the first embodiment, explanation thereof is omitted. A point different from the flowchart illustrated in FIG. 16 is that use application impression range obtaining (S3101) is added after the content impression estimation process of S1602. Moreover, contents of a process of determining the setting ranges of the target impression in S3102 are different from the contents of the process of S1603.

In S3101, the use application impression obtaining component 3001 obtains the impression ranges suiting the use application category obtained from the poster creation condition designation component 201. Specifically, the use application impression obtaining component 3001 obtains the use application category of the poster to be created that is designated by the user in the category list box 815 of FIG. 8. Then, the use application impression obtaining component 3001 obtains the impression ranges associated with the obtained use application category, from the HDD 104. As described above, the database in which each use application category is associated with the impression ranges suiting the use application category is held in advance in the HDD 104. The use application impression obtaining component 3001 outputs the obtained impression ranges to the setting range determination component 303.

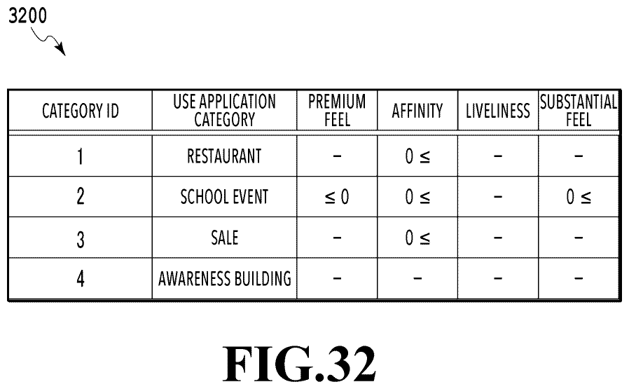

A database 3200 in which the impression ranges suiting each use application category are recorded is explained by using FIG. 32. The column of use application category illustrated in FIG. 32 illustrates types of the use application category that can be designated by the user in the category list box 815 of FIG. 8, and restaurant, school event, sale, and awareness building are illustrated as examples herein. In each of the columns of premium feel, affinity, liveliness, and substantial feel, the impression ranges suiting the respective use application categories are set for the corresponding impression factor. Note that the types and number of the use application categories are not limited to those in this example, and may include other use application categories.

Explanation is given by using affinity as an example. In the case where a poster for a restaurant is to be created, a poster with negative affinity, that is a poster that gives an impression of no feeling of affinity is unsuitable. Accordingly, in the case where the use application category is restaurant, the impression range of affinity is set to be 0 or more. Meanwhile, in the case where a poster of awareness building application is to be created, there may be a poster with positive affinity to cause a viewer to be emphatic or a poster with negative affinity to give the viewer a sense of crisis. In other words, in the poster of awareness building application, there is particularly no suitable range for affinity, and the target value of affinity may be any value. Accordingly, the range for affinity is not set in the use application category of awareness building in the database 3200, and is expressed as “−” in FIG. 32.

Moreover, explanation is given by using premium feel as an example. In the case where a poster for school event is to be created, there are not many cases where premium feel is required, but an impression of negative premium feel, that is a casual impression is suitable for the poster for school event. Accordingly, the range of premium feel in the use application category of school event is set to 0 or less. Meanwhile, in the case where a poster for sale use application is to be created, there are cases where premium feel is required and cases where a casual impression is required, depending on products to be sold. Accordingly, the range for premium feel is not set in the use application category of sales in the database 3200.

Note that the impression ranges suiting each of the use application categories can be determined by using posters of use applications defined as the use application category and the impression estimation model saved in the poster impression quantification process explained in FIG. 10. In the present embodiment, for each of combinations of the impression factors and the use application categories, the impression range suiting the use application category is assumed to be determined according to Formula 3 and Formula 4 described below.

$$lower limit value = {μ}_{c} - {σ}_{c} \qquad ( 3 )$$

$$upper limit value = {μ}_{c} + {σ}_{c} \qquad ( 4 )$$

In these formulae, c is an index of the use application category, μ_{c} is an average of the impression values of the poster group corresponding to the use application category c, and σ_{c} is a standard deviation of the impression values of the poster group corresponding to the use application category c. Note that the method of determining the impression range suiting the use application category is not limited to this, and for example, oc in Formula 3 and Formula 4 may be replaced by a predetermined fixed value. Moreover, for example, the impression range may be set to 0 or more in the case where μ_{c} is 0 or more, and set to be less than 0 in the case where μ_{c} is less than 0. The method of determining the impression range may be any method as long as the impression range suiting each use application category can be determined.

In S3102, for each impression factor, the setting range determination component 303 determines the setting range of the target impression based on the impression of the content obtained in S1602 and the impression range suiting the use application category obtained in S3101. In the present embodiment, the setting range determination component 303 determines an intersection range of the impression range suiting the use application category obtained in S3101 and the setting range of the target impression determined from the impression of the content in a method similar to the method explained in S1603 of the first embodiment, and outputs the intersection range. Note that there may occur a situation where there is no intersection range. In this case, the same measure as that in the first embodiment may be executed.

As explained above, according to the third embodiment, the setting ranges of the target impression designatable by the user are determined based on the use application category designated by the user in addition to the impression of the content designated by the user, and the UI (operation object) is changed. This facilitates designation of the target impression suiting not only the content to be arranged in the poster but also the use application of the poster. Accordingly, it is possible to determine the setting ranges of the target impression more precisely reflecting the intention of the user in the poster creation, and the usability is thus improved. The user can obtain a poster with an intended design in fewer times of trial.

Although the preferable embodiments according to the present disclosure are explained above with reference to the attached drawings, the present disclosure is not limited to these examples. For example, in the third embodiment, the templates may be selected and presented instead of the poster generation as explained in the second embodiment. Moreover, it is apparent that those skilled in the art can come up with various change examples or modification examples within the disclosed scope of the technical idea, and these change examples and modification examples are understood to also belong to the technical scope of the present disclosure as a matter of course.

According to the present disclosure, usability in the case where the user designates the target impression is improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An information processing apparatus configured to generate data of a creation product, the information processing apparatus comprising:
a reception unit configured receive designation of a content to be arranged in the creation product and designation of a target impression from a user, the target impression being an impression that is required to be eventually given by the creation product; and
a control unit configured to perform control such that a first range being a range of the target impression designatable by the user in a case where the reception unit receives designation of a first content is different from a second range that is the range of the target impression designatable by the user in a case where the reception unit receives designation of a second content different from the first content.

2. The information processing apparatus according to claim 1, wherein the first range and the second range are limited to ranges smaller than a reference range set in advance.

3. The information processing apparatus according to claim 1, further comprising a display unit configured to display a screen that receives the designation of the target impression from the user, wherein
the screen is configured to allow the user to recognize the first range or the second range.

4. The information processing apparatus according to claim 1, wherein the control unit determines the first range based on an impression estimated from the first content, and determines the second range based on an impression estimated from the second content.

5. The information processing apparatus according to claim 4, wherein the control unit determines the first range to be a range including an impression value estimated from the first content, and determines the second range to be a range including an impression value estimated from the second content.

6. The information processing apparatus according to claim 1, wherein the target impression is designated by using values indicating degrees of a plurality of impression factors, respectively.

7. The information processing apparatus according to claim 6, wherein the control unit performs control such that the impression factors designatable by the user vary between the first range and the second range.

8. The information processing apparatus according to claim 6, wherein the control unit performs control such that ranges of the values designatable by the user vary between the first range and the second range.

9. The information processing apparatus according to claim 3, wherein
the display unit displays an operation object for performing the designation of the target impression by the user, on the screen, and
the control unit reflects the first range or the second range in the operation object.

10. The information processing apparatus according to claim 1, further comprising a first generation unit configured to generate data of the creation product including the content received by the reception unit, based on the target impression received by the reception unit.

11. The information processing apparatus according to claim 10, wherein a value indicating a difference between an impression estimated from the data of the creation product generated by the first generation unit and the target impression received by the reception unit is smaller than a predetermined threshold.

12. The information processing apparatus according to claim 1, further comprising a second generation unit configured to generate template data of the creation product including the content received by the reception unit, based on the target impression received by the reception unit.

13. The information processing apparatus according to claim 9, wherein words representing a plurality of different impressions are displayed as the operation object to be selectable.

14. The information processing apparatus according to claim 1, wherein
the reception unit further receives designation of a use application of the creation product, and
the control unit further performs control such that the range of the target impression designatable by the user in a case where the reception unit receives designation of a first use application is different from the range of the target impression designatable by the user in a case where the reception unit receives designation of a second use application different from the first use application.

15. An information processing method of generating data of a creation product, the information processing method comprising:
receiving designation of a content to be arranged in the creation product and designation of a target impression from a user, the target impression being an impression that is required to be eventually given by the creation product; and
performing control such that a first range being a range of the target impression designatable by the user in a case where designation of a first content is received in the receiving is different from a second range that is the range of the target impression designatable by the user in a case where designation of a second content different from the first content is received in the receiving.

16. A non-transitory computer readable storage medium storing a program which causes a computer to execute an information processing method of generating data of a creation product, the information processing method comprising:
receiving designation of a content to be arranged in the creation product and designation of a target impression from a user, the target impression being an impression that is required to be eventually given by the creation product; and
performing control such that a first range being a range of the target impression designatable by the user in a case where designation of a first content is received in the receiving is different from a second range that is the range of the target impression designatable by the user in a case where designation of a second content different from the first content is received in the receiving.

17. The storage medium according to claim 16, wherein the first range and the second range are limited to ranges smaller than a reference range set in advance.

18. The storage medium according to claim 16, wherein
the information processing method further comprises displaying a screen that receives the designation of the target impression from the user, and
the screen is configured to allow the user to recognize the first range or the second range.

19. The storage medium according to claim 16, wherein, in the controlling, the first range is determined based on an impression estimated from the first content, and the second range is determined based on an impression estimated from the second content.

20. The storage medium according to claim 19, wherein, in the controlling, the first range is determined to be a range including an impression value estimated from the first content, and the second range is determined to be a range including an impression value estimated from the second content.
